(19) United States
(12) Patent Application Publication
(10) Pub. No.: US 2005/0209365 A1
(43) Pub. Date: Sep. 22, 2005

(54) Ink composition for ink jet printing and image forming method

(75) Inventors: Kimihiko Ookubo, Tokyo (JP); Norio Miura, Sagamihara-shi (JP); Masato Nishizeki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/077,079

(22) Filed: Mar. 11, 2005

(30) Foreign Application Priority Data
Mar. 17, 2004 (JP) JP2004-075829

(51) Int. Cl. C03C 17/00; C09D 11/00

(52) U.S. Cl. 523/160; 523/161

(57) ABSTRACT

An ink composition for ink jet printing is disclosed, containing a compound represented by the following formula (a-1) or (a-2) and an alicyclic epoxy compound represented by the following formula (b). An image forming method by use thereof is also disclosed.

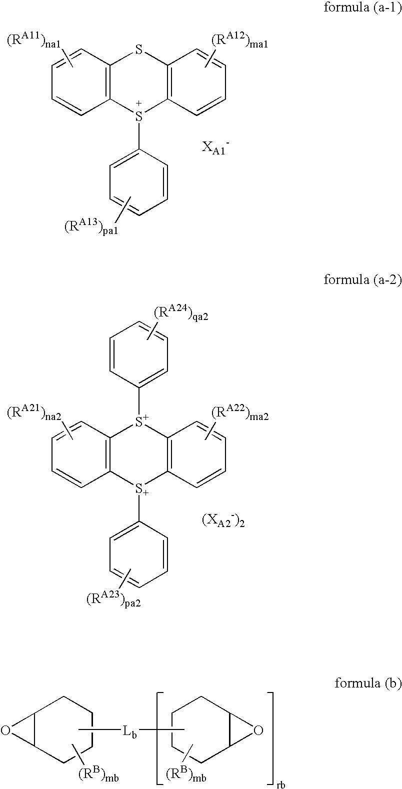

### FIELD OF THE INVENTION

The present invention relates to an ink compositions for use in ink jet printing which contain a specific thianthrene ring compound and a specific alicyclic epoxy compound, and image forming methods by use thereof.

### BACKGROUND OF THE INVENTION

Recently, ink jet recording systems which enable facile image formation at low cost, have been applied to various printing fields including photography, various types of printing, marking and special printing such as color filters. Specifically, the use of a recording apparatus for ejecting and controlling minute droplets, inks exhibiting improved color reproducibility, fastness and ejection suitability and special paper exhibiting marked enhancement in ink absorptivity, color forming properties of coloring material and surface gloss has enabled obtaining images equal to photographic image quality. Enhanced image quality in recent ink jet recording systems was achieved only by using a recording apparatus, an ink and special paper all together.

However, an ink jet printing system requiring special paper limits recording medium, producing problems such as increased cost of recording medium. Accordingly, there have been made many attempts of ink jet recording onto receiving medium different from special paper. Specific examples thereof include a phase change ink jet system employing solid wax ink at room temperature, a solvent type ink jet system using an ink composed mainly of organic quick-drying solvents and a UV ink jet system in which curing is performed by UV rays after recording. Of these, the UV ink jet system exhibits relatively low odor, as compared to a solvent type ink jet system, and has recently been noted in terms of quick-drying property and recording onto recording medium exhibiting no ink-absorptivity to be feasible, as disclosed in JP-A No. 6-200204 (hereinafter, the term, JP-A refers to Japanese Patent Application Publication) and Japanese Translation of PCT International Patent Application Publication No. 2000-504778.

Radical polymerization type inks are generally known as an ultraviolet curing ink and have been used in practice. On the other hand, cationic polymerization type inks have not yet been used in practice though there are advantages such that polymerization inhibition due to oxygen, as observed in radical polymerization type ink, does not result, low intensity light sources are usable, no typical odor of acryl monomers is produced and the material is low-irritant. One of the causes is the problem that conventional ultraviolet curing type cationic ink jet inks often cause cracking or peeling in image areas when a recording medium is bent, especially at high density portions after curing the image areas so that coverage on a recording medium is limited, making it difficult to obtain high density images.

### SUMMARY OF THE INVENTION

The present invention has come into being in view of the foregoing problems, and it is an object of the invention to provide an ink composition for use in ink jet printing, exhibiting superior ink curability and resulting in high quality images without blotting, which does not cause cracking nor peeling in image areas when the recording medium is bent especially in the high density image areas after curing the image areas.

In one aspect the invention is directed to an ink composition for ink jet printing comprising a compound represented by the following formula (a-1) or (a-2) and an alicyclic epoxy compound represented by the following formula (b): 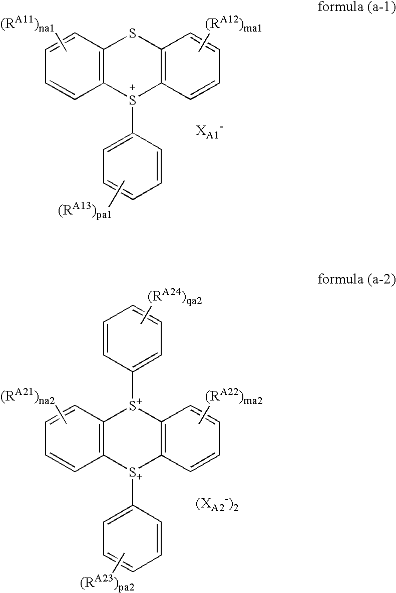
wherein R^{A11}, R^{A12}, R^{A13}, R^{A21}, R^{A22}, R^{A23} and R^{A24} are each a substituent; na1, na2, ma1 and ma2 are each an integer of 0 to 4; pa1, pa2, qa1 and qa2 are each an integer of 0 to 5; X_{A1}⁻ and X_{A2}⁻ are each a counter anion; 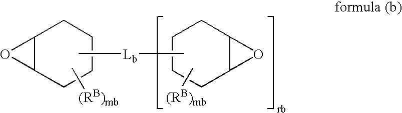
wherein R^{B} is a substituent; mb is an integer of 1 to 3 and rb is an integer of 1 to 3; L_{b} is a (rb+1)-valent linkage group having 1 to 15 carbon atoms or a single bond.

In another aspect the invention is directed to an image forming method comprising ejecting a droplet of an ink composition through a recording head with at least one nozzle and onto a surface of a recording material and exposing the recording material with the ink composition on the surface thereof to an actinic ray to cure the ink composition, wherein the ink composition is one as described above.

The present invention has come into being as a result of the inventors' extensive study of the foregoing problems. Thus, it was discovered that an ink solution comprised of an ink composition containing a specific thianthrene ring compound and a specific alicyclic epoxy compound exhibits a high reactivity, resulting in high quality images and an advantage was unexpectedly found that when images formed on a recording medium are cured and then, the recording medium is bent at a high density region, neither cracking nor peeling is caused.

### DETAILED DESCRIPTION OF THE INVENTION

In formulas (a-1) and (a-2), R^{A11}, R^{A12}, R^{A13}, R^{A21}, R^{A22}, R^{A23} and R^{A24} each represent a substituent. In this invention, this substituent is not specifically limited and examples of such a substituent include an alkyl group (e.g., methyl, ethyl, propyl, isopropyl, tert-butyl, pentyl, hexyl, octyl, dodecyl, tridecyl, tetradecyl, pentadecyl, cyclopentyl, cyclohexyl), an alkenyl group (e.g., vinyl, allyl), an alkynyl group (e.g., ethynyl, propargyl), an aromatic hydrocarbon group (e.g., phenyl. naphthyl), an aromatic heterocyclic group (e.g., furyl, thienyl, pyridyl, pyridazyl, pyrimidyl, pyrazyl, triazyl, imidazolyl, pyrazolyl, thiazolyl, benzoimidazolyl, benzooxazolyl, quinazolyl, phthalazyl), a heterocyclic group (e.g., pyrrolidyl, imidazolidyl, morpholyl group, oxazolidyl), an alkoxy group (e.g., methoxy, ethoxy, propyloxy, pentyloxy, hexyloxy, octyloxy, dodecyloxy), a cycloalkoxy group (e.g., cyclopentyloxy, cyclohexyloxy), an aryloxy group (e.g., phenoxy, naphthyloxy), an alkylthio group (e.g., methylthio, ethylthio, propylthio, pentylthio, hexylthio, octylthio, dodecylthio), a cycloalkylthio group (e.g., cyclopentylthio, cyclohexylthio), an arylthio group (e.g., phenylthio, naphthylthio), an alkoxycarbonyl group (e.g., methyloxycarbonyl, ethyloxycarbonyl, butyloxycarbonyl, octyloxycarbonyl, dodecyloxycarbonyl), an aryloxycarbonyl group (e.g., phenyloxycarbonyl, naphthyloxycarbonyl), a sulfamoyl group (e.g., aminosulfonyl, methylaminosulfonyl, dimethylaminosulfonyl, butylaminosulfonyl, hexylaminosufonyl, cyclohexylaminosulfonyl, octylaminosulfonyl, dodecylaminosulfonyl, phenylaminosulfonyl, naphthylaminosulfonyl, 2-pyridylaminosulfonyl), an acyl group (e.g., acetyl, ethylcarbonyl, propylcarbonyl, pentylcarbonyl, cyclohexylcarbonyl, octylcarbonyl, 2-ethylhexylcarbonyl, dodecylcarbonyl, phenylcarbonyl, naphthylcarbonyl, pyridylcarbonyl), an acyloxy group (e.g., acetyloxy, ethylcarbonyloxy, butylcarbonyloxy, octylcarbonyloxy, dodecylcarbonyloxy, phenylcarbonyloxy), an amido group (e.g., methylcarbonylamino, ethylcarbonylamino, dimethylcarbonylamino, propylcarbonylamino, pentylcarbonylamino, cyclohexylcarbonylamino, 2-ethylhexylcarbonylamino, octylcarbonylamino, dodecylcarbonylamino, phenylcarbonylamino, naphthylcarbonylamino), a carbamoyl group (e.g., aminocarbony, methylaminocarbonyl, dimethylaminocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl, naphthylaminocarbonyl, 2-pyridylaminocarbonyl), a ureido group (e.g., methylureido, ethylureido, pentylureido, cyclohexylureido, octylureido, dodecylureido, phenylureido, naphthylureido, 2-pyridylureido), a sufinyl group (e.g., methylsulfinyl, ethylsulfinyl, butylsulfinyl, cyclohexylsulfinyl, 2-ethylhexylsulfinyl, dodecysulfinyl, phenylsufinyl, naphthylsulfinyl, 2-pyridylsulfiny), an alkylsulfonyl group (e.g., methylsulfinyl, ethylsulfinyl, butylsulfinyl, cyclohexylsulfinyl, 2-ethylhexylsulfinyl, dodecylsufinyl), an arylsulfonyl group (e.g., phenylsulfonyl, naphthylsulfonyl, 2-pyridylsulfonyl), an amino group (e.g., amino, ethylamino, dimethylamino, butylamino, cyclopentylamino, 2-ethylhexylamino, dodecylamino, anilino, naphthylamine, 2-pyridylamino), a halogen atom (e.g., fluorine atom, chlorine atom, bromine atom, iodine atom), a fluorohydrocarbon group (e.g., fluoromethyl; trifluoromethyl, pentafluoroethyl, pentafluorophenyl), cyano group, mercapto group, a silyl group (e.g., trimethylsilyl, triisopropylsilyl, triphenylsilyl, phenyldiethylsilyl), hydroxyl group, nitro group, and carboxyl group. The foregoing substituents may further substituted by a substituent as defined above, and the plural substituents described above may combine with each other to form a ring. R^{A11}, R^{A12}, R^{A13}, R²¹, R^{A22}, R^{A23} and R^{A24}, which are each plural, each may be the same or different.

In the foregoing formulas, na1 and na2, and ma1 and ma2 are each an integer of 0 to 4; pa1, pa2 and qa2 are each an integer of 0 to 5, and each of the foregoing is preferably an integer of 0 to 2, and more preferably 0 or 1.

In the foregoing formulas, X_{A1}⁻ and X_{A2}⁻ are each a counter anion, examples of the counter anion include halide ions such as F⁻, Cl⁻, and Br⁻; complex ions such as BF₄⁻, B(C₆F₅)₄⁻, PF₆⁻, AsF₆⁻, SbF₆⁻ and GaF₆⁻; sulfonate ions such as a benzenesulfonic acid ion (e.g., p-CH₃C₆H₄SO₃⁻, C₆H₅SO₃⁻), an alkylsulfonic acid ion (e.g., CH₃SO₃⁻, C₂H₅SO₃⁻), a fluoroalkylsulfonic acid ion (e.g., CF₃SO₃⁻, C₂F₅SO₃⁻, C₉F₁₉SO₃⁻), a fluoroalkylbenzenesulfonic acid ion (e.g., p-CF₃—C₆H₄SO₃, p-CF₃—C₆F₄SO₃⁻), and a fluorobenzenesulfonic acid ion (e.g., p-F—C₆H₄SO₃⁻, C₆F₅SO₃⁻). Of these counter anions, PF₆⁻, BF₄⁻, SbF₆⁻, GaF₆⁻, AsF₆⁻, B(C₆F₅)₄⁻ and a fluoroalkylsulfonic acid ion (e.g., CF₃SO₃⁻, C₂F₅SO₃⁻, C₉F₁₉SO₃⁻) are preferred, and BF₄⁻, B(C₆F₅)₄⁻ and PF₆⁻ are more preferred.

Specific examples of compounds of formulas (a-1) and (a-2) are shown below, but the invention is not limited to these.

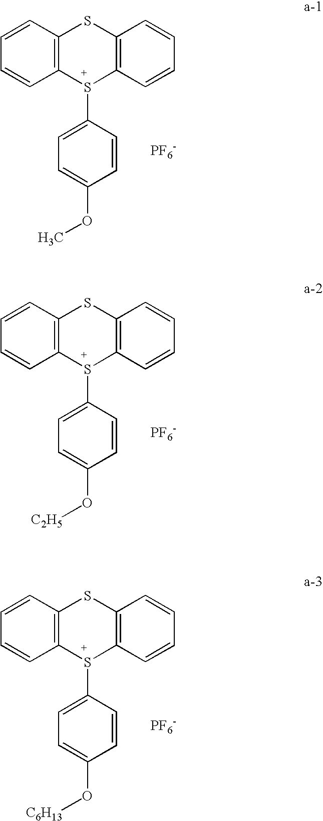

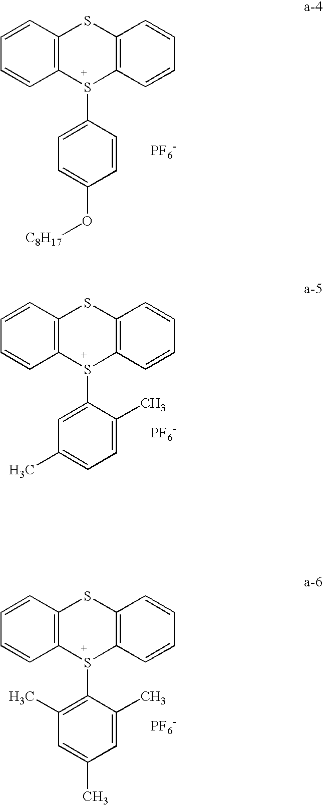

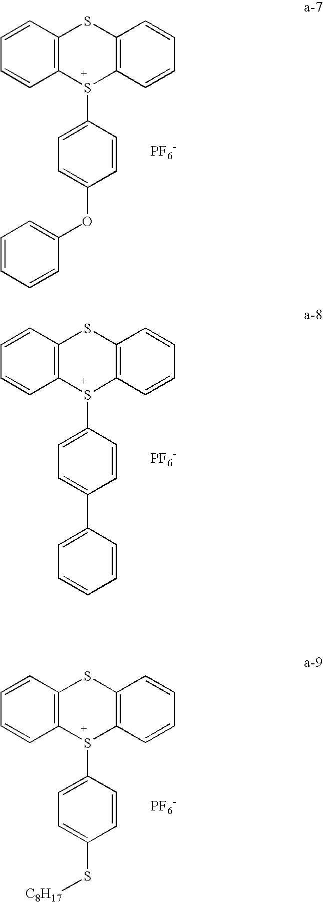

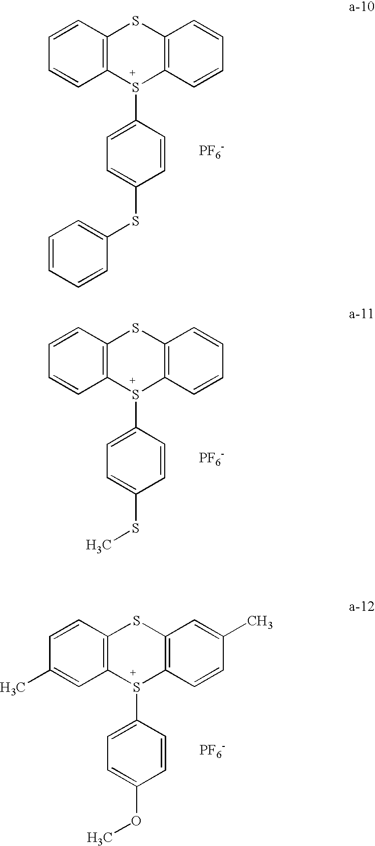

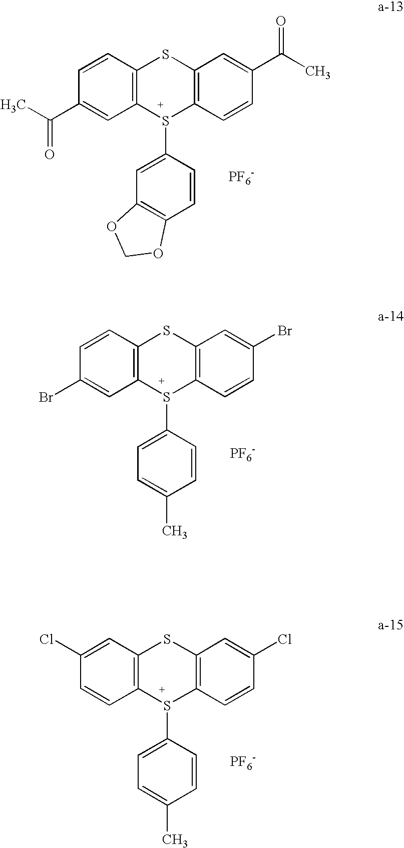

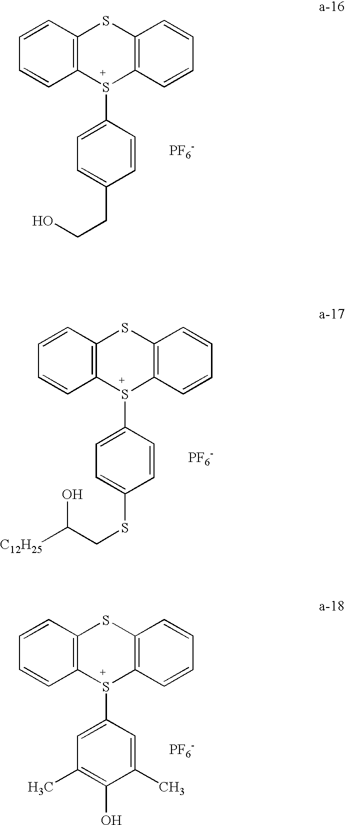

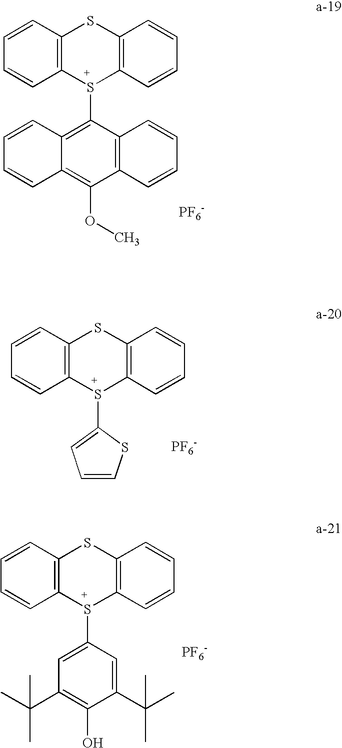

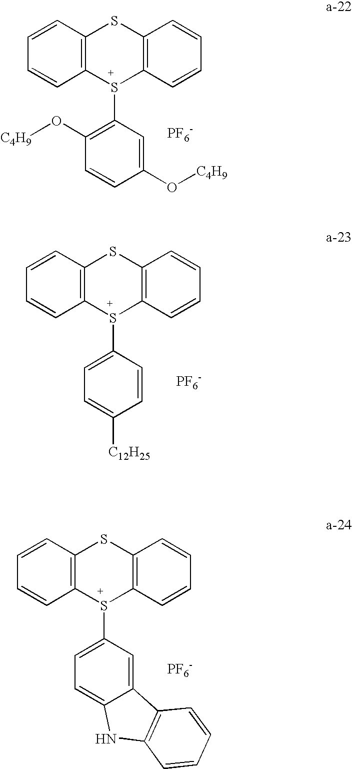

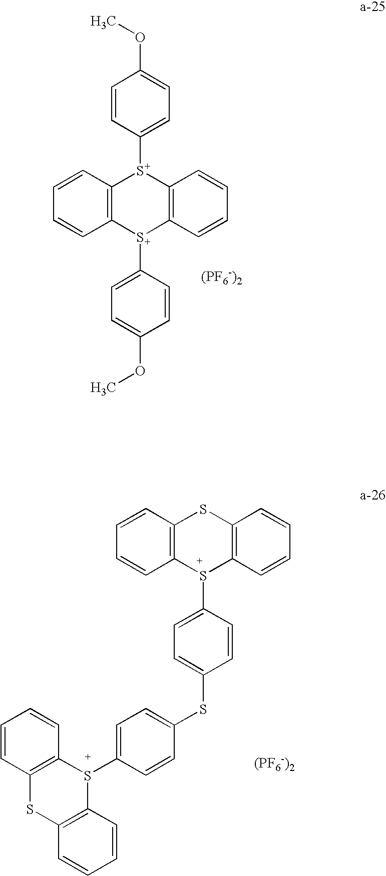

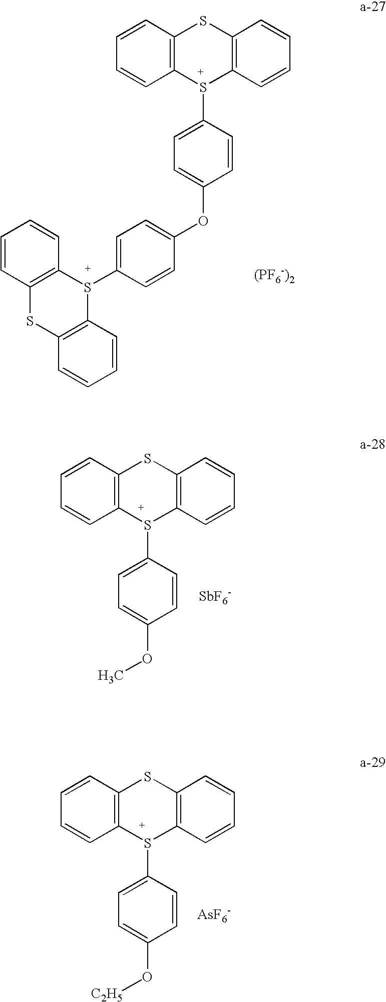

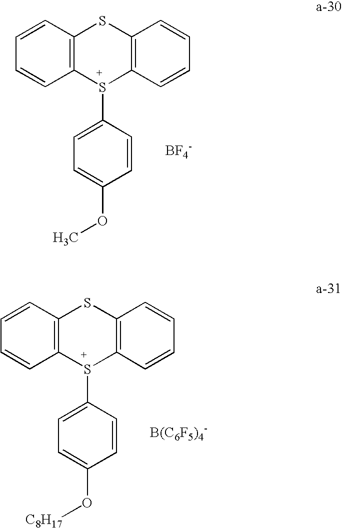

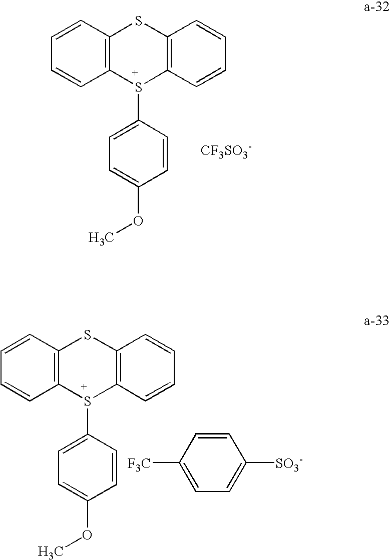

The compound of formula (a-1) or (a-2) is contained preferably in an amount of from 0.1 to 0.20 parts by weight, based on 100 parts by weight of a cation-polymerizable compound. An amount of less than 0.1 parts by weight of the compound makes it difficult to achieve sufficient sensitivity and even in an amount exceeding 20 parts by weight of the compound, further enhanced sensitivity cannot be achieved. The content is more preferably from 1 to 10 parts by weight, and still more preferably from 1 to 5 parts by weight. The compound of formula (a-1) or (a-2) can be used singly or in their combination. When at least two compounds of formula (a-1) or (a-2) are used, the total content of the compounds is preferably within the range described above, based on 100 parts by weight of a cation-polymerizable compound.

Next, there will be described compounds of formula (b). In formula (b), R^{B} represents a substituent and examples of such a substituent include an alkyl group (e.g., methyl, ethyl, propyl, isopropyl, tert-butyl, pentyl, hexyl, octyl, dodecyl, tridecyl, tetradecyl, pentadecyl, cyclopentyl, cyclohexyl), an alkenyl group (e.g., vinyl, allyl), an alkynyl group (e.g., ethynyl, propargyl), an aromatic hydrocarbon group (e.g., phenyl. naphthyl), an aromatic heterocyclic group (e.g., furyl, thienyl, pyridyl, pyridazyl, pyrimidyl, pyrazyl, triazyl, imidazolyl, pyrazolyl, thiazolyl, benzoimidazolyl, benzooxazolyl, quinazolyl, phthalazyl), and a heterocyclic group (e.g., pyrrolidyl, imidazolidyl, morpholyl group, oxazolidyl). The substituent of R^{B} may be further substituted by a substituent. Examples of a group capable of being substituted onto the foregoing substituent include, in addition to the above-described alkyl, alkenyl, alkynyl groups, aromatic hydrocarbon group, aromatic heterocyclic group and heterocyclic group, an alkoxy group (e.g., methoxy, ethoxy, propyloxy, pentyloxy, hexyloxy, octyloxy, dodecyloxy), a cycloalkoxy group (e.g., cyclopentyloxy, cyclohexyloxy), an aryloxy group (e.g., phenoxy, naphthyloxy), an alkylthio group (e.g., methylthio, ethylthio, propylthio, pentylthio, hexylthio, octylthio, dodecylthio), a cycloalkylthio group (e.g., cyclopentylthio, cyclohexylthio), an arylthio group (e.g., phenylthio, naphthylthio), an alkoxycarbonyl group (e.g., methyloxycarbonyl, ethyloxycarbonyl, butyloxycarbonyl, octyloxycarbonyl, dodecyloxycarbonyl), an aryloxycarbonyl group (e.g., phenyloxycarbonyl, naphthyloxycarbonyl), a sulfamoyl group (e.g., aminosulfonyl, methylaminosulfonyl, dimethylaminosulfonyl, butylaminosulfonyl, hexylaminosufonyl, cyclohexylaminosulfonyl, octylaminosulfonyl, dodecylaminosulfonyl, phenylaminosulfonyl, naphthylaminosulfonyl, 2-pyridylaminosulfonyl), an acyl group (e.g., acetyl, ethylcarbonyl, propylcarbonyl, pentylcarbonyl, cyclohexylcarbonyl, octylcarbonyl, 2-ethylhexylcarbonyl, dodecylcarbonyl, phenylcarbonyl, naphthylcarbonyl, pyridylcarbonyl), an acyloxy group (e.g., acetyloxy, ethylcarbonyloxy, butylcarbonyloxy, octylcarbonyloxy, dodecylcarbonyloxy, phenylcarbonyloxy), an amido group (e.g., methylcarbonylamino, ethylcarbonylamino, dimethylcarbonylamino, propylcarbonylamino, pentylcarbonylamino, cyclohexylcarbonylamino, 2-ethylhexylcarbonylamino, octylcarbonylamino, dodecylcarbonylamino, phenylcarbonylamino, naphthylcarbonylamino), a carbamoyl group (e.g., aminocarbonyl, methylaminocarbonyl, dimethylaminocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl, naphthylaminocarbonyl, 2-pyridylaminocarbonyl), a ureido group (e.g., methylureido, ethylureido, pentylureido, cyclohexylureido, octylureido, dodecylureido, phenylureido, naphthylureido, 2-pyridylureido), a sufinyl group (e.g., methylsulfinyl, ethylsulfinyl, butylsulfinyl, cyclohexylsulfinyl, 2-ethylhexylsulfinyl, dodecysulfinyl, phenylsufinyl, naphthylsulfinyl, 2-pyridylsulfiny), an alkylsulfonyl group (e.g., methylsulfinyl, ethylsulfinyl, butylsulfinyl, cyclohexylsulfinyl, 2-ethylhexylsulfinyl, dodecylsufinyl), an arylsulfonyl group (e.g., phenylsulfonyl, naphthylsulfonyl, 2-pyridylsulfonyl), an amino group (e.g., amino, ethylamino, dimethylamino, butylamino, cyclopentylamino, 2-ethylhexylamino, dodecylamino, anilino, naphthylamine, 2-pyridylamino), a halogen atom (e.g., fluorine atom, chlorine atom, bromine atom, iodine atom), a fluorohydrocarbon group (e.g., fluoromethyl, trifluoromethyl, pentafluoroethyl, pentafluorophenyl), cyano group, mercapto group, a silyl group (e.g., trimethylsilyl, triisopropylsilyl, triphenylsilyl, phenyldiethylsilyl), hydroxyl group, nitro group, and carboxyl group. The foregoing substituents may further substituted by a substituent as defined above, and the plural substituents described above may combine with each other to form a ring. Of these substituents represented by R^{B}, an alkyl group is preferred, an alkyl group having 1 to 3 carbon atoms is more preferred, methyl or ethyl group is still more preferred and methyl group is most preferred.

In the formula (b), nb is an integer of 1 to 3, and preferably 1 or 2; when nb is 2 or more, plural R^{B}s may be the same or different and plural R^{B}s may also combine with each other at any position to form a ring; rb is an integer of 1 to 3, and preferably 1 or 2.

L_{b} is a (rb+1)-valent linkage group having 1 to 15 carbon atoms or a single bond wherein the linkage group optionally contains an oxygen atom or a sulfur atom in the main chain. Examples of a bivalent linkage group having 1 to 15 carbon atoms which may contain an oxygen atom or a sulfur atom in the main chain include hydrocarbon groups and groups formed by combination of the hydrocarbon groups with groups of —O—, —S—, —CO— and CS—, as shown below:
methylene group [—CH₂—]
ethylidene group [>CHCH₃]
isopropylidene [>C(CH₃)₂]
1,2-ethylene group [—CH2CH₂—]
1,2-propylene group [—CH(CH₃)CH₂—]
1,3-propanediyl group [—CH₂CH₂CH₂—]
2,2-dimethyl-1,3-propanediyl group [—CH₂C(CH₃)₂CH₂—]
2,2-dimethoxy-1,3-propanediyl group [—CH₂C(OCH₃)₂CH₂—]
2,2-dimethoxy-1,3-propanediyl group [—CH2C(CH₂OCH₃)₂CH₂—]
1-methyl-1,3-propanediyl group [—CH(CH₃)CH₂CH₂—]
1,4-butanediyl group [—CH₂CH₂CH₂CH₂—]
1,5-pentanediyl group [—CH₂CH₂CH₂CH₂CH₂—]
oxydiethylene group [—CH₂CH₂OCH₂CH₂—]
thiodiethylene group [—CH₂CH₂SCH₂CH₂—]
3-oxothiodiethylene group [—CH₂CH₂SOCH₂CH₂—]
3,3-dioxothiodiethylene group [—CH₂CH₂SOCH₂CH₂—]
1,4-dimethyl3-oxa-1,5-pentanediyl [—CH(CH₃)CH₂OCH(CH₃)CH₂—]
3-oxopentanediyl group [—CH₂CH₂COCH₂CH₂—]
1,5-dioxo-3-oxapantanediyl group [—COCH₂OCH₂CO—]
4-oxa-1,7-heptanediyl group [—CH₂CH₂CH₂OCH₂CH₂CH₂—]
3,6-dioxa-1,8-octanediyl group [—CH₂CH₂OCH₂CH₂OCH₂CH₂—]
1,4,7-trimethyl-3,6-dioxa-1,8-octanediyl group [—CH(CH₃)CH₂OCH(CH₃)CH₂OCH(CH₃)CH₂—]
5,5-dimethyl-3,7-dioxa-1,9-nonanediyl group [—CH₂CH₂OCH₂C(CH₃)CH₂OCH₂CH₂—]
5,5-dimethoxy-3,7-dioxa-1,9-nonanediyl group [—CH₂CH₂OCH₂C(OCH₃)₂CH₂OCH₂CH₂—]
5,5-dimethoxymethyl-3,7-dioxa-1,9-nonanediyl group [—CH₂CH₂OCH₂C(CH₂OCH₃)₂CH₂OCH₂CH₂—]
4,7-dioxo-3,8-dioxa-1,10-decanediyl group [—CH₂CH₂OCOCH₂CH₂CO—OCH₂CH₂—]
3,8-dioxo-4,7-dioxa-1,10-decanediyl group [—CH₂CH₂COOCH₂CH₂O—COCH₂CH₂—]
1,3-cyclopentanediyl group [-1,3-C₅H₈—]
1,2-cyclohexanediyl group [-1,2-C₆H₁₀—]
1,3-cyclohexanediyl group [-1,3-C₆H₁₀—]
1,4-cyclohexanediyl group [-1,4-C₆H₁₀—]
2,5-tetrahydrofurandiyl[2,5-C₄H₆O—]
p-phenylene group [-p-C₆H₄—]
m-phenylene group [-m-C₆H₄—]
α,α′-o-xylilene group [-o-CH₂—C₆H₄—CH₂—]
α,α′-m-xylilene group [-m-CH₂—C₆H₄—CH₂—]
α,α′-p-xylilene group [-p-CH₂—C₆H₄—CH₂—]
furan-2,5-diyl-bismethylene group [2,5-CH₂—C₄H₂O—CH₂—]
thiophene-2,5-diyl-bismethylene group [2,5-CH₂—C₄H₂S—CH₂—]
isopropylidene-bis-p-phenylene group [-p-C₆H₄—C(CH₃)₂-p-C₆H₄—]

Further, a tri-valent or more valent linkage group (i.e., linkage group having three or more valency) is a group which is formed by removing necessary hydrogen atom(s) at any position of the foregoing bivalent linkage group or a group formed by combining the foregoing group with at least one group selected from —O—, —S—, —CO— and —CS— groups.

L_{b} may be substituted and examples of a substituent include a halogen atom (e.g., fluorine atom, chlorine atom, bromine atom, iodine atom), an alkyl group having 1 to 6 carbon atoms (e.g., methyl, ethyl, propyl, isopropyl, butyl9, an alkoxy group having 1 to 6 carbon atoms (e.g., methoxy, ethoxy, n-propoxy, iso-propoxy, n-butoxy, tert-butoxy), an acyl group (e.g., acetyl, propionyl, trifluoroacetyl), an acyloxy group (e.g., acetoxy, propionyloxy, trifluoroacetoxy), and an alkoxycarbonyl group (e.g., methoxycarbonyl, ethoxycarbonyltert-butoxycarbonyl). Of these substituents, a halogen atom, an alkyl group and an alkoxy group are preferred. L_{b} is preferably a bivalent linkage group having 1 to 8 carbon atoms which may contain an oxygen atom or a sulfur atom in the main chain, and more preferably a bivalent linkage group having 1 to 5 carbon atoms which may contain an oxygen atom or a sulfur atom in the main chain. L_{b} is also preferably one which has a branch at a secondary or higher carbon atom in the main chain, and more preferably one which has a branch at a tertiary carbon atom in the main chain.

An alicyclic epoxy compound represented by the foregoing formula (b) is preferably an alicyclic epoxy compound represented by the following formula (A): 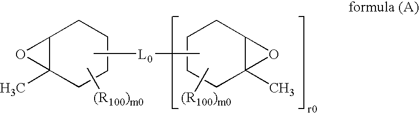
wherein R₁₀₀ is a substituent; m0 is an integer of from 0 to 2 and r0 is an integer of from 1 to 3; L₀ is a (r0+1)-valent linkage group having 1 to 15 carbon atoms, or a single bond wherein the linkage group may contain an oxygen atom or a sulfur atom in the main chain.

The foregoing alicyclic epoxy compound of formula (A) is preferably at least one selected from alicyclic epoxy compounds represented by the following formula (I) or (II): 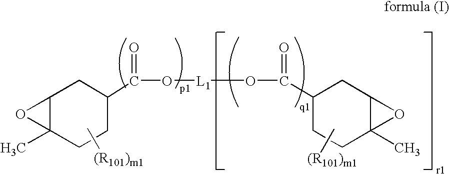
wherein R₁₀₁ is a substituent; m1 is an integer of from 0 to 2, p1 and q1 are each 0 or 1, and r1 is an integer of from 1 to 3; L₁ is a (r1+1)-valent linkage group having 1 to 15 carbon atoms, or a single bond wherein the linkage group may contain an oxygen atom or a sulfur atom in the main chain; 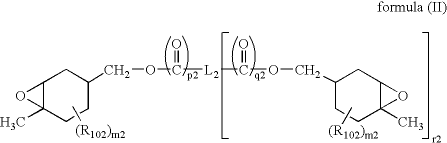
wherein R₁₀₂ is a substituent; m2 is an integer of from 0 to 2, p2 and q2 are each 0 or 1, and r2 is an integer of from 1 to 3; L₂ is a (r2+1)-valent linkage group having 1 to 15 carbon atoms or a single bond wherein the linkage group may contain an oxygen atom or a sulfur atom in the main chain.

In the formulas (A), (I) and (II), R₁₀₀, R₁₀₁ and R₁₀₂ are each a substituent. Examples of a substituent include a halogen atom) e.g., fluorine atom, chlorine atom, bromine atom, iodine atom), an alkyl group having 1 to 6 carbon atoms (e.g., methyl, ethyl, propyl, isopropyl, butyl9, an alkoxy group having 1 to 6 carbon atoms (e.g., methoxy, ethoxy, n-propoxy, iso-propoxy, n-butoxy, tert-butoxy), an acyl group (e.g., acetyl, propionyl, trifluoroacetyl), an acyloxy group (e.g., acetoxy, propionyloxy, trifluoroacetoxy), and an alkoxycarbonyl group (e.g., methoxycarbonyl, ethoxycarbonyltert-butoxycarbonyl). On the foregoing substituents, an alkyl group, alkoxy group and alkoxycarbonyl group are preferred.

In the formulas (A), (I) and (II), m0, m1 and m2 are each an integer of 0 to 2, and preferably 0 or 1. L₀ is a (r0+1)-valent linkage group having 1 to 15 carbon atoms which may contain an oxygen atom or a sulfur atom in the main chain, or a single bond; L₁ is a (r1+1)-valent linkage group having 1 to 15 carbon atoms which may contain an oxygen atom or a sulfur atom in the main chain, or a single bond; and L₂ is a (r2+1)-valent linkage group having 1 to 15 carbon atoms which may contain an oxygen atom or a sulfur atom in the main chain, or a single bond. Examples of a bivalent linkage group having 1 to 15 carbon atoms which may contain an oxygen atom or a sulfur atom in the main chain include hydrocarbon groups, as shown below and groups formed by combination of the hydrocarbon groups with groups of —O—, —S—, —CO— and CS—:
methylene group [—CH₂—]
ethylidene group [>CHCH₃]
isopropylidene [>C(CH₃)₂]
1,2-ethylene group [—CH2CH₂—]
1,2-propylene group [—CH(CH₃)CH₂—]
1,3-propanediyl group [—CH₂CH₂CH₂—]
2,2-dimethyl-1,3-propanediyl group [—CH₂C(CH₃)₂CH₂—]
2,2-dimethoxy-1,3-propanediyl group [—CH₂C(OCH₃)₂CH₂—]
2,2-dimethoxy-1,3-propanediyl group [—CH2C(CH₂OCH₃)₂CH₂—]
1-methyl-1,3-propanediyl group [—CH(CH₃)CH₂CH₂—]
1,4-butanediyl group [—CH₂CH₂CH₂CH₂—]
1,5-pentanediyl group [—CH₂CH₂CH₂CH₂CH₂—]
oxydiethylene group [—CH₂CH₂OCH₂CH₂—]
thiodiethylene group [—CH₂CH₂SCH₂CH₂—]
3-oxothiodiethylene group [—CH₂CH₂SOCH₂CH₂—]
3,3-dioxothiodiethylene group [—CH₂CH₂SOCH₂CH₂—]
1,4-dimethyl3-oxa-1,5-pentanediyl [—CH(CH₃)CH₂OCH(CH₃)CH₂—]
3-oxopentanediyl group [—CH₂CH₂COCH₂CH₂—]
1,5-dioxo-3-oxapantanediyl group [—COCH₂OCH₂CO—]
4-oxa-1,7-heptanediyl group [—CH₂CH₂CH₂OCH₂CH₂CH₂—]
3,6-dioxa-1,8-octanediyl group [—CH₂CH₂OCH₂CH₂OCH₂CH₂—]
1,4,7-trimethyl-3,6-dioxa-1,8-octanediyl group [—CH(CH₃)CH₂OCH(CH₃)CH₂OCH(CH₃)CH₂—]
5,5-dimethyl-3,7-dioxa-1,9-nonanediyl group [—CH₂CH₂OCH₂C(CH₃)CH₂OCH₂CH₂—]
5,5-dimethoxy-3,7-dioxa-1,9-nonanediyl group [—CH₂CH₂OCH₂C(OCH₃)₂CH₂OCH₂CH₂—]
5,5-dimethoxymethyl-3,7-dioxa-1,9-nonanediyl group [—CH₂CH₂OCH₂C(CH₂OCH₃)₂CH₂OCH₂CH₂—]
4,7-dioxo-3,8-dioxa-1,10-decanediyl group [—CH₂CH₂OCOCH₂CH₂CO—OCH₂CH₂—]
3,8-dioxo-4,7-dioxa-1,10-decanediyl group [—CH₂CH₂COOCH₂CH₂O—COCH₂CH₂—]
1,3-cyclopentanediyl group [-1,3-C₅H₈—]
1,2-cyclohexanediyl group [-1,2-C₆H₁₀—]
1,3-cyclohexanediyl group [-1,3-C₆H₁₀—]
1,4-cyclohexanediyl group [-1,4-C₆H₁₀—]
2,5-tetrahydrofurandiyl[2,5-C₄H₆O—]
p-phenylene group [-p-C₆H₄—]
m-phenylene group [-m-C₆H₄—]
α,α′-o-xylilene group [-o-CH₂—C₆H₄—CH₂—]
α,α′-m-xylilene group [-m-CH₂—C₆H₄—CH₂—]
α,α′-p-xylilene group [-p-CH₂—C₆H₄—CH₂—]
furan-2,5-diyl-bismethylene group [2,5-CH₂—C₄H₂O—CH₂—]
thiophene-2,5-diyl-bismethylene group [2,5-CH₂—C₄H₂S—CH₂—]
isopropylidene-bis-p-phenylene group [-p-C₆H₄—C(CH₃)₂-p-C₆H₄—]

Further, a tri-valent or more-valent linkage group (which is a linkage group having three or more valency) is a group which is formed by removing necessary hydrogen atom(s) at any position of the foregoing bivalent linkage group or a group formed by combining the foregoing group with at least one group selected from —O—, —S—, —CO— and —CS— groups.

L₀, L₁ and L₂ each may be substituted and examples of a substituent include a halogen atom (e.g., fluorine atom, chlorine atom, bromine atom, iodine atom), an alkyl group having 1 to 6 carbon atoms (e.g., methyl, ethyl, propyl, isopropyl, butyl), an alkoxy group having 1 to 6 carbon atoms (e.g., methoxy, ethoxy, n-propoxy, iso-propoxy, n-butoxy, tert-butoxy), an acyl group (e.g., acetyl, propionyl, trifluoroacetyl), an acyloxy group (e.g., acetoxy, propionyloxy, trifluoroacetoxy), and an alkoxycarbonyl group (e.g., methoxycarbonyl, ethoxycarbonyl, tert-butoxycarbonyl). Of these substituents, a halogen atom, an alkyl group and an alkoxy group are preferred. L₀, L₁ and L₂ are each preferably a bivalent linkage group having 1 to 8 carbon atoms which may contain an oxygen atom or a sulfur atom in the main chain, and more preferably a bivalent linkage group having 1 to 5 carbon atoms which may contain an oxygen atom or a sulfur atom in the main chain.

In the formulas, p1 and q1 are each 0 or 1, and (p1+q1) is preferably 1 or more; p2 and q2 are each 0 or 1, and preferably 1.

Specific examples of preferred alicyclic epoxy compound are shown below but are by no means limited to these.

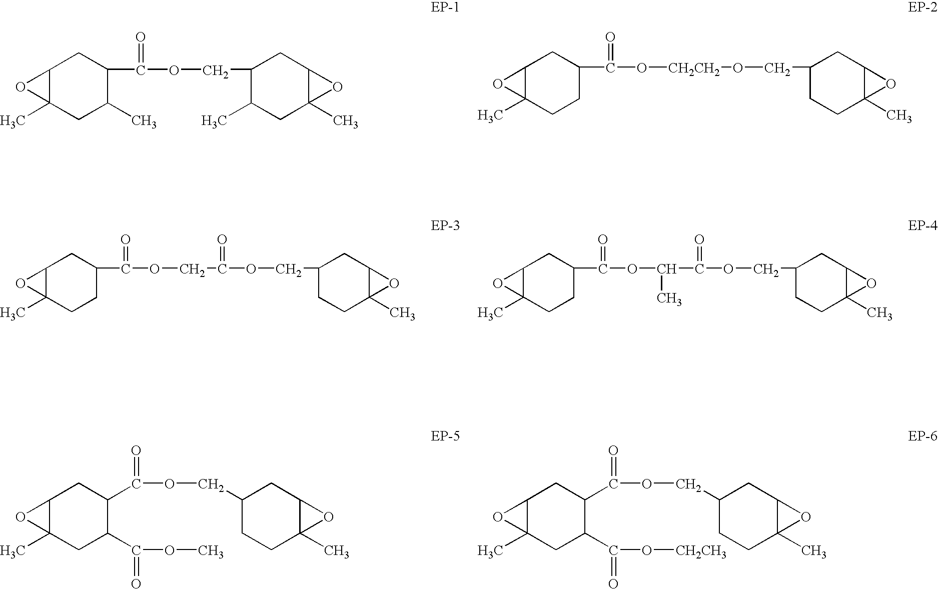

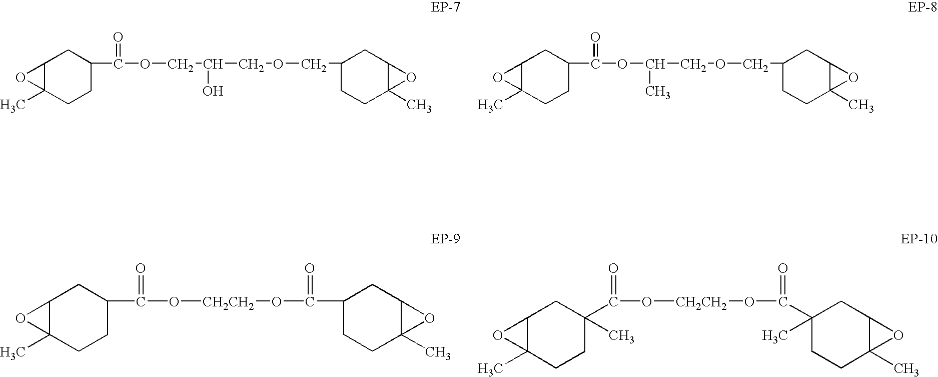

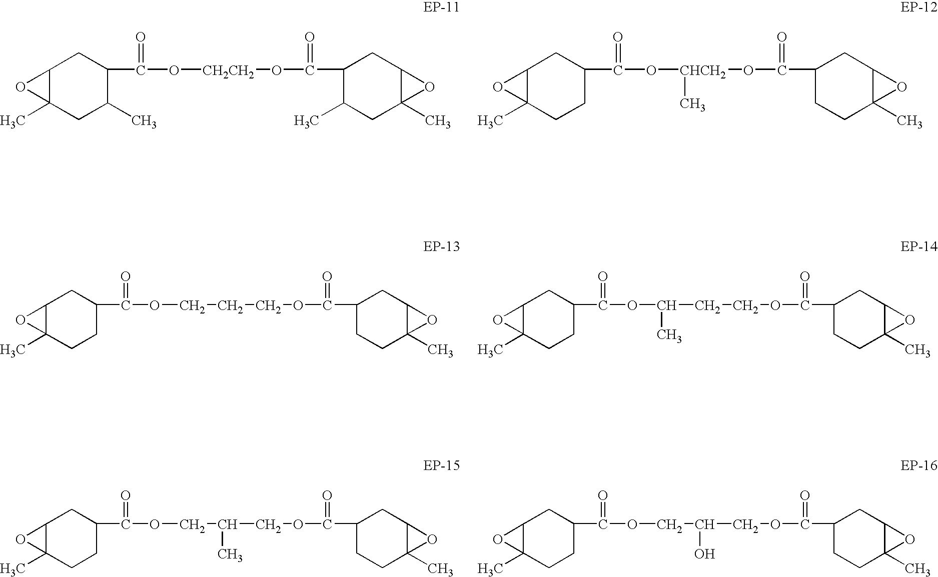

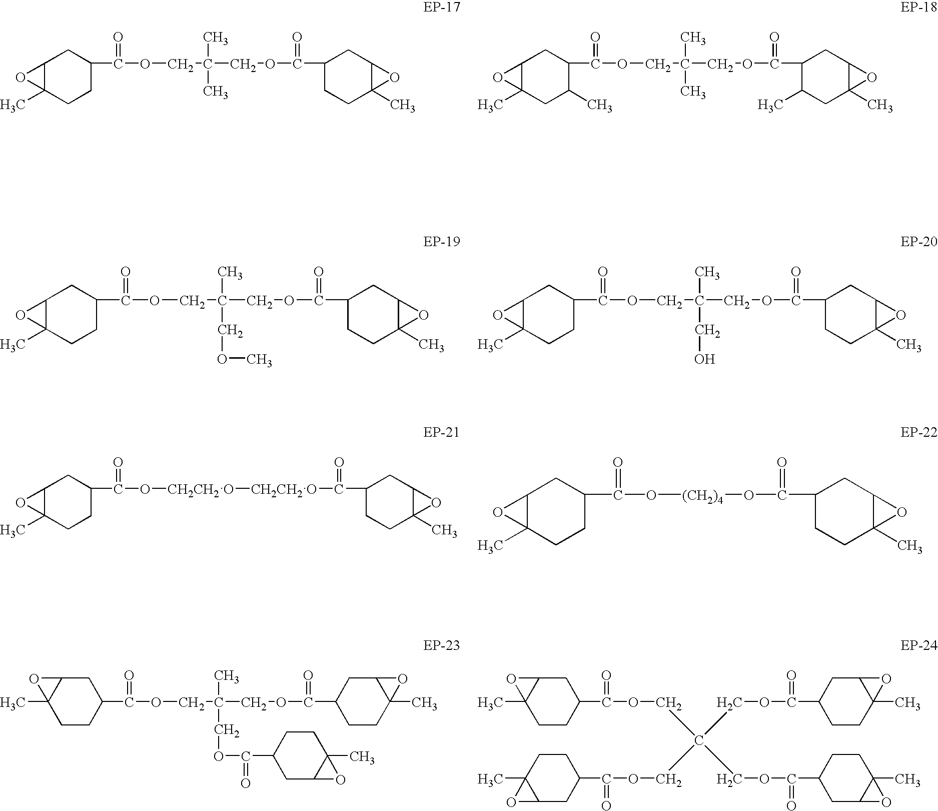

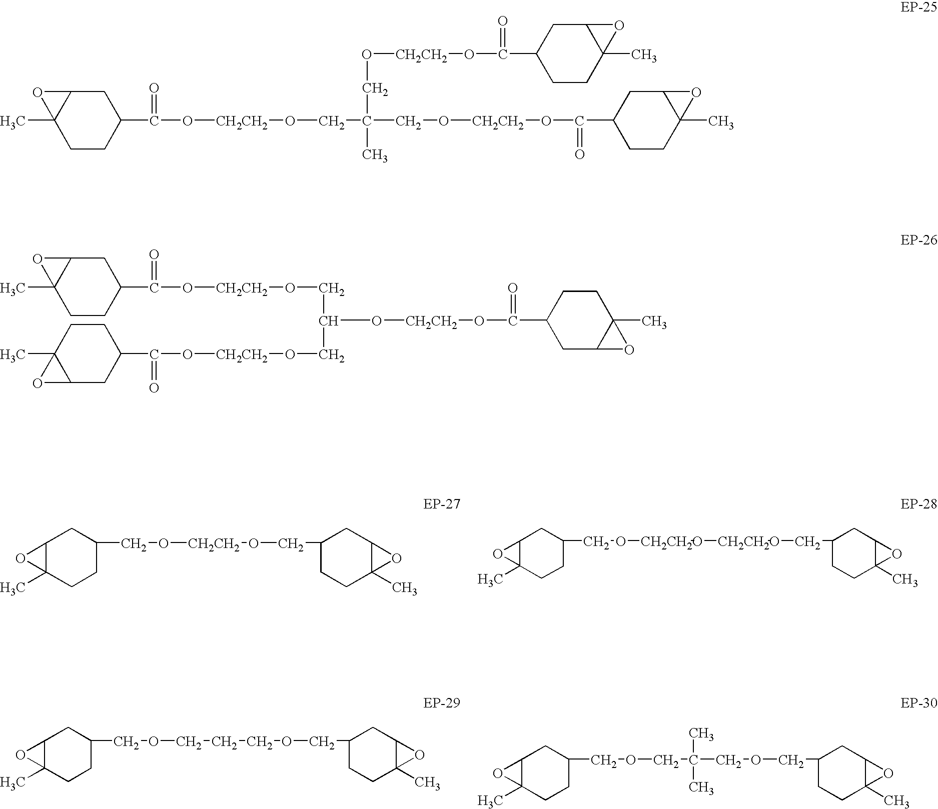

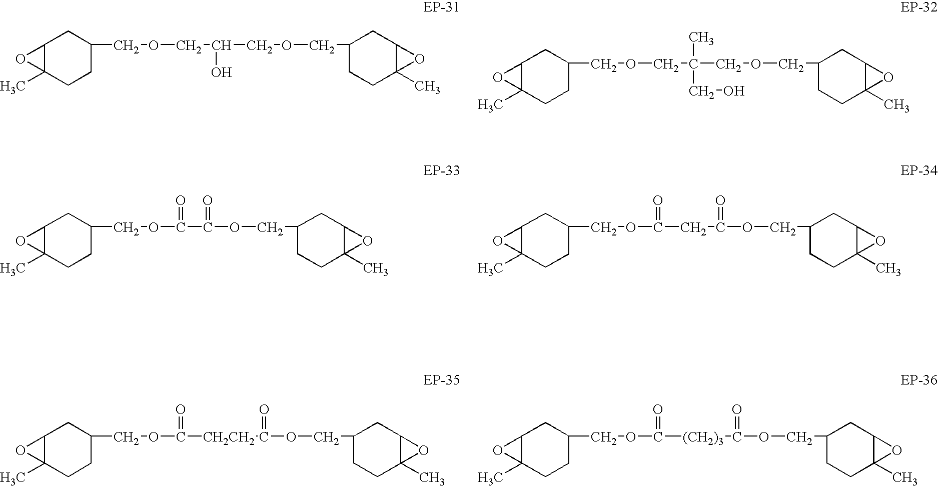

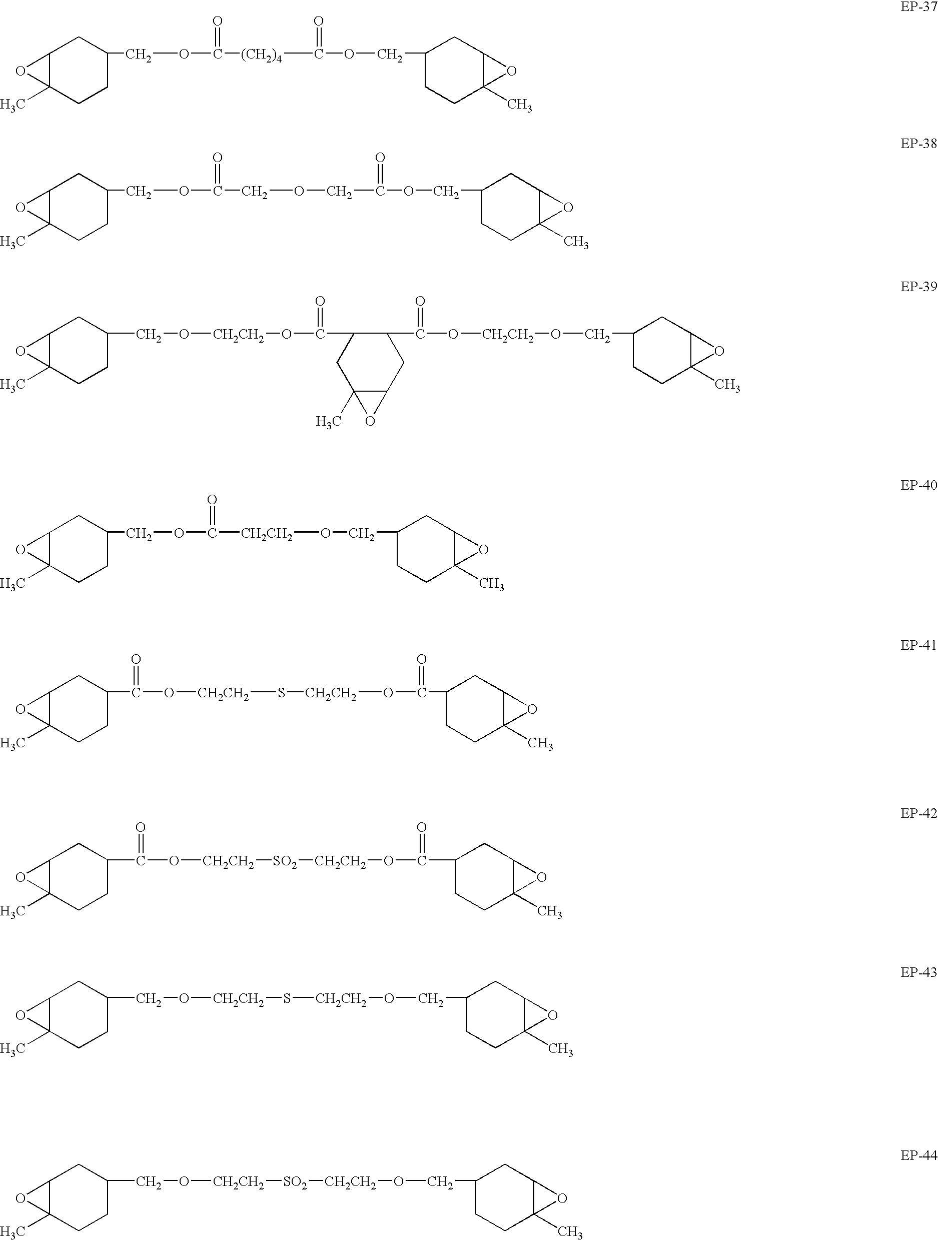

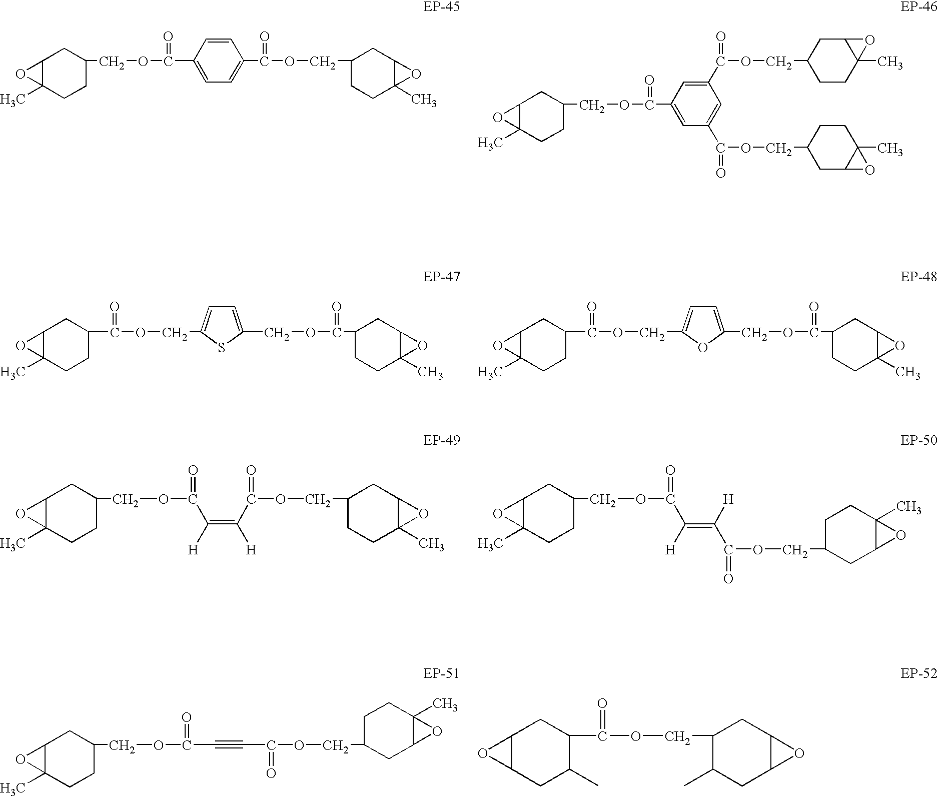

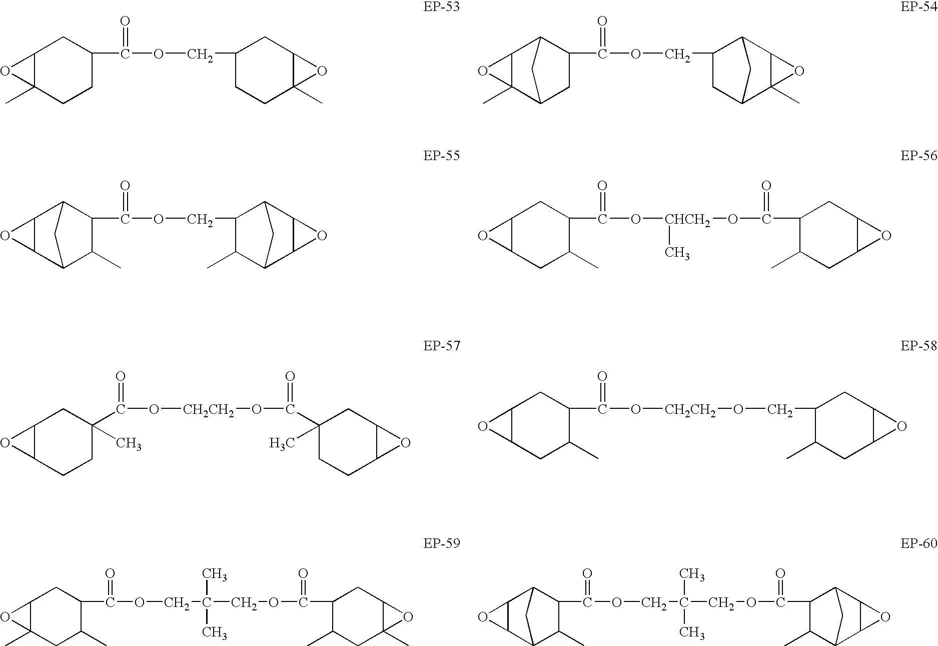

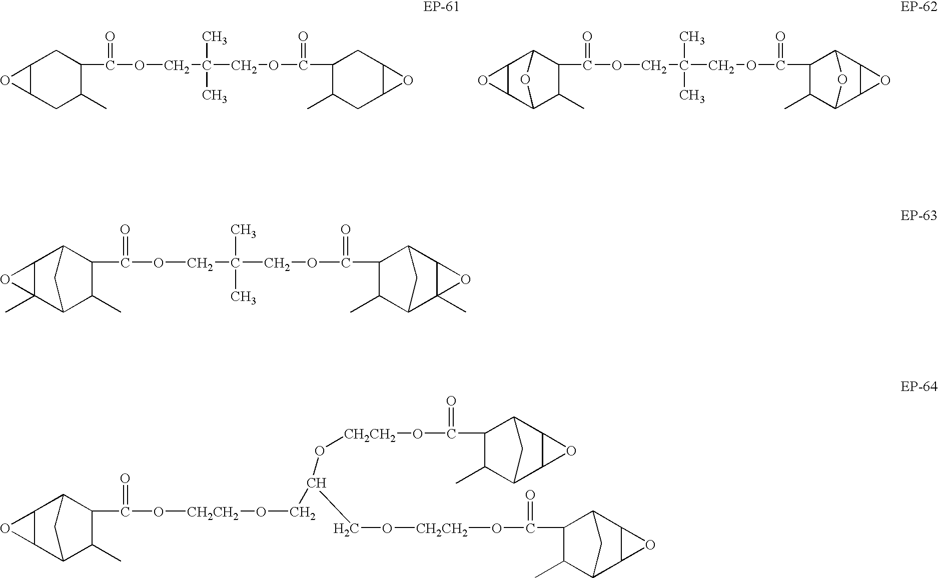

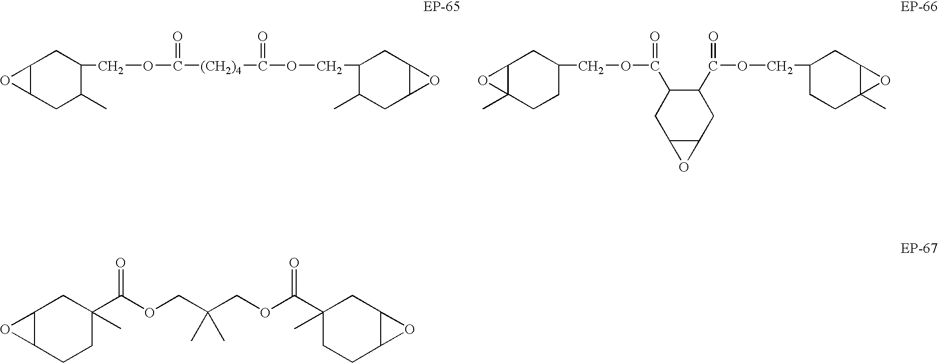

In the respective alicyclic epoxy compounds described above, the value of a molecular weight divided by the total number of epoxy groups contained in the molecule is preferably from 160 to 300.

The alicyclic epoxy compounds of formula (A), (I) or (II) can be synthesized in accordance with methods described, for example, in U.S. Pat. Nos. 2,745,847, 2,750,395, 2,853,498, 2,8,53,499 and 2,863,881. According to the methods described in the foregoing patent documents, synthesis examples of the afore-mentioned compounds are shown below but are not limited to these.

### SYNTHESIS EXAMPLE 1

### Synthesis of Exemplified Compound EP-9

Exemplified compound EP-9,1 ethyleneglycol-bis(4-methyl-3,4-epoxy-cyclohexanecarboxylate was synthesized in the following manner.

### Synthesis of methyl-(4-methyl-3-cyclohexanecarboxylate

Using isoprene and methyl acrylate as raw material, methyl-(4-methyl-3-cyclohexanecarboxylate) was synthesized through commonly known Diels-Alder reaction. The reaction was undergone under the reaction conditions described in J. Organomet. Chem., 285, 1985, 333-342; and J. Phys. Chem., 95, 5, 1992, 2293-2297; Acta. Chem. Scand. 47, 6, 1993, 581-591; U.S. Pat. No. 1,944,731; and an objective compound was obtained at a high yield.

Ethyleneglycol-bis(4-methyl-cyclohexanecarboxylate) was synthesized as follows. Thus, to 340 g of methyl-(4-methyl-3-cyclohexanecarboxylate) and 62 g of ethylene glycol, 1 g of toluene sulfonic acid monohydrate was added and reacted at 80 to 90° C. for 8 hr. The reaction mixture was washed with aqueous sodium bicarbonate solution and subjected to vacuum distillation to obtain an objective compound. The yield was 92%.

### Synthesis of Exemplified Compound EP-9

To 2 lit. three-necked flask was added 306 g of ethyleneglycol-bis(4-methyl-3-cyclohexanecarboxylate) and further thereto, 770 g of an acetone solution having a peracetic acid content of 2% [containing 192 g (2.5 mol) of peracetic acid] was dropwise added over a period of 4 hr., while maintaining the internal temperature at 35 to 40° C. After completion of addition, the reaction continued further for 4 hr. at the same temperature. The reaction mixture was allowed to stand for one night at −11° C. and then, the residual amount of peracetic acid was checked and it was confirmed that at least 98% of the theoretical amount was reacted.

Subsequently, the reaction mixture was diluted with 1 lit. of toluene and heated at 50° C. under reduced pressure using a water-jet aspirator to distil away low boiling components until no distillate was formed. The remained reaction composition was subjected to vacuum distillation to obtain an objective compound, EP-9. The yield was 78%.

The structure of the thus obtained compound, EP-9 was identified by NMR and MASS spectroscopic analysis:

H¹-NHR (CDCl₃) δ (ppm) 1.31 (s, 6H, CH₃—), 1.45 to 2.50 (m, 14H, cyclohexane ring), 3.10 (m, 2H, epoxy root), and 4.10 (s, 4H, —CH₂—O—).

### SYNTHESIS EXAMPLE 2

### Synthesis of Exemplified Compound EP-12

Exemplified compound EP-12, propane-1,2-diol-bis(4-methyl-3,4-epoxy-cyclohexanecarboxylate) was synthesized in the following manner.

### Synthesis of propane-1,2-diol-bis(4-methyl-3-cyclohexanecarboxylate

To 340 (2 mol) of methyl-(4-methyl-3-cyclohexanecarboxylate) and 76 g (1 mol) of propane-1,2-diol was added 1 g of toluenesulfonic acid monohydrate and was reacted at 80 to 90° C. for 8 hr. The reaction mixture was washed with aqueous sodium bicarbonate solution and subjected to vacuum distillation to obtain an objective compound. The yield was 90%.

### Synthesis of Exemplified Compound EP-12

To 2 lit. three-necked flask was added 320 g (1 mol) of propane-1,2-diol-bis(4-methyl-3-cyclohexanecarboxylate) and further thereto, 770 g of an acetone solution having a peracetic acid content of 2% [containing 192 g (2.5 mol) of peracetic acid] was dropwise added over a period of 4 hr., while maintaining the internal temperature at 35 to 40° C. After completion of addition, the reaction continued further for 4 hr. at the same temperature. The reaction mixture was allowed to stand for one night at −11° C. and then, the residual amount of peracetic acid was checked and it was confirmed that at least 98% of the theoretical amount was reacted.

Subsequently, the reaction mixture was diluted with 1 lit. of toluene and heated at 50° C. under reduced pressure using a water-jet aspirator to distil away low boiling components until no distillate was formed. The remained reaction composition was subjected to vacuum distillation to obtain an objective compound, EP-12. The yield was 75%.

The structure of the thus obtained compound, EP-12 was identified by NMR and MASS spectroscopic analysis:

H¹-NHR (CDCl₃) δ (ppm): 1.23 (d, 3H, CH₃—), 1.31 (s, 6H, CH₃—), 1.45 to 2.50 (m, 14H, cyclohexane ring), 3.15 (m, 2H, epoxy root), 4.03 (m, 1H, —O—CH₂—) 4.18 (s, 4H, —O—CH₂—) and 5.15 (m, 1H, —O—CH₂—).

### SYNTHESIS EXAMPLE 3

### Synthesis of Exemplified Compound EP-17

Exemplified compound EP-17, 2,2-dimethyl-propane-1,3-diol-bis(4-methyl-3,4-epoxy-cyclohexanecarboxylate) was synthesized in the following manner.

### Synthesis of propane-1,3-diol-bis(4-methyl-3-cyclohexanecarboxylate

To 340 g (2 mol) of methyl-(4-methyl-3-cyclohexanecarboxylate) and 104 g (1 mol) of 2,2-dimethyl-propane-1,3-diol was added 1 g of toluenesulfonic acid monohydrate and was reacted at 80 to 90° C. for 12 hr. The reaction mixture was washed with aqueous sodium bicarbonate solution and subjected to vacuum distillation to obtain an objective compound. The yield was 86%.

### Synthesis of Exemplified Compound EP-17

To 2 lit. three-necked flask was added 348 g (1 mol) of 2,2-dimethyl-propane-1,3-diol-bis(4-methyl-3-cyclohexanecarboxylate) and further thereto, 770 g of an acetone solution having a peracetic acid content of 2% [containing 192 g (2.5 mol) of peracetic acid] was dropwise added over a period of 4 hr., while maintaining the internal temperature at 35 to 40° C. After completion of addition, the reaction continued further for 4 hr. at the same temperature. The reaction mixture was allowed to stand for one night at −11° C. and then, the residual amount of peracetic acid was checked and it was confirmed that at least 98% of the theoretical amount was reacted.

Subsequently, the reaction mixture was diluted with 1 lit. of toluene and heated at 50° C. under reduced pressure using a water-jet aspirator to distil away low boiling components until no distillate was formed. The remained reaction composition was subjected to vacuum distillation to obtain an objective compound, EP-17. The yield was 70%.

The structure of the thus obtained compound, EP-17 was identified by NMR and MASS spectroscopic analysis:

H¹-NHR (CDCl₃) δ (ppm): 1.96 (s, 6H, CH₃—), 1.31 (s, 6H, CH₃—), 1.45 to 2.50 (m, 14H, cyclohexane ring), 3.00 (m, 2H, epoxy root), 3.87 (s, 4H, —O—CH₂—).

### SYNTHESIS EXAMPLE 4

### Synthesis of Exemplified Compound EP-31

Exemplified compound EP-31, 1,3-bis(4-methyl-3,4-epoxy-cyclohexylmethyloxy)-2-propanol was synthesized in the following manner.

### Synthesis of 4-methyl-3-cyclohexenylmethanol

Using isoprene and methyl acrylate as raw material, 4-methyl-3-cyclohexenylaldehyde was synthesized through commonly known Diels-Alder reaction. The reaction was undergone under the reaction conditions described in J. Amer. Chem. Soc. 119, 15, 1997, 3507-3512; Tetrahedron Lett., 40, 32, 1999, 5817-822 and an objective compound was obtained at a high yield. Subsequently, the obtained compound was reduced and 4-methyl-3-cyclohexenylmethanol was obtained at a high yield.

### Synthesis of 1,2-bis(4-methyl-cyclohexenylmethyloxy)-2-propanol

To 1 lit. of acetone solution containing 284 g (2 mol) of 4-methyl-3-cyclohexenylmethanol and 92 g (1 mol) of epichlorohydrin, 305 g (2.2 mol) of potassium carbonate was added and reacted at 50° C. for 8 hr. Precipitated salts was filtered out and the reaction solution was concentrated under reduced pressure and residual crude product was subjected to vacuum distillation to obtain an objective compound. The yield was 90%.

### Synthesis of Exemplified Compound EP-31

To 2 lit. three-necked flask was added 308 g (1 mol) of 1,2-bis(4-methyl-3-cyclohexenylmethyloxy)-2-propanol and further thereto, 770 g of an acetone solution having a peracetic acid content of 2% [containing 192 g (2.5 mol) of peracetic acid] was dropwise added over a period of 4 hr., while maintaining the internal temperature at 35 to 40° C. After completion of addition, the reaction continued further for 4 hr. at the same temperature. The reaction mixture was allowed to stand for one night at −11° C. and then, the residual amount of peracetic acid was checked and it was confirmed that at least 98% of the theoretical amount was reacted.

Subsequently, the reaction mixture was diluted with 1 lit. of toluene and heated at 50° C. under reduced pressure using a water-jet aspirator to distil away low boiling components until no distillate was formed. The remained reaction composition was subjected to vacuum distillation to obtain an objective compound, EP-31. The yield was 83%. The structure of the thus obtained compound, EP-31 was identified by NMR and MASS spectroscopic analysis:

H¹-NHR (CDCl₃) δ (ppm): 1.31 (s, 6H, CH₃—), 1.4 to 2.0 (m, 14H, cyclohexane ring), 2.7 (s, 1H, —OH), 3.10 (m, 2H, epoxy root), 3.45 (d, 4H, —CH₂—O—), 3.50 (m, 4H, —CH₂—O—) and 3.92 (m, 1H, >CH—).

### SYNTHESIS EXAMPLE 5

### Synthesis of Exemplified Compound EP-35

Exemplified compound EP-35, bis(4-methyl-3,4-epoxy-cyclohexylmethyl)oxalate was synthesized in the following manner.

### Synthesis of bis-(4-methyl-3-cyclohexenylmethyl)succinate

To 1 lit. of toluene containing 284 g (2 mol) of 4-methyl-3-cyclohexenylmethylmethanol and 100 g (1 mol) of succinic acid anhydride was added 5 g of toluenesulfonic acid monohydrate and was reacted at 110 to 120° C. for 12 hr, while removing produced water using a water removing apparatus. The reaction mixture was washed with aqueous sodium bicarbonate solution and subjected to vacuum distillation to obtain an objective compound. The yield was 90%.

### Synthesis of Exemplified Compound EP-35

To 2 lit. three-necked flask was added 335 g (1 mol) of bis(4-methyl-3-cyclohexenylmethyl)succinate and further thereto, 770 g of an acetone solution having a peracetic acid content of 2% [containing 192 g (2.5 mol) of peracetic acid] was dropwise added over a period of 4 hr., while maintaining the internal temperature at 35 to 40° C. After completion of addition, the reaction continued further for 4 hr. at the same temperature. The reaction mixture was allowed to stand for one night at −11° C. and then, the residual amount of peracetic acid was checked and it was confirmed that at least 98% of the theoretical amount was reacted.

Subsequently, the reaction mixture was diluted with 1 lit. of toluene and heated at 50° C. under reduced pressure using a water-jet aspirator to distil away low boiling components until no distillate was formed. The remained reaction composition was subjected to vacuum distillation to obtain an objective compound, EP-35. The yield was 75%.

The structure of the thus obtained compound, EP-17 was identified by NMR and mass spectroscopic analysis:

H¹-NHR (CDCl₃) δ (ppm): 1.31 (s, 6H, CH₃—), 1.4 to 2.0 (m, 14H, cyclohexane ring), 3.10 (m, 2H, epoxy root), 2.62 (s, 4H, —CH₂—CO—) and 4.05 (d, 4H, —CH₂—O—).

Other alicyclic epoxy compounds can similarly be synthesized at a high yield.

The ink composition for ink jet printing of this invention preferably contains a photolytically acid-generating agent capable of generating an acid upon exposure to ultraviolet rays, together with the foregoing alicyclic epoxy compound of formula (A), (I) or (II).

The alicyclic epoxy compound of formula (b), (A), (I) or (II) is contained preferably in an amount of from 1 to 70 parts by weight (more preferably from 5 to 60, and still more preferably 5 to 50 parts by weight), based on 100 parts by weight of a cation-polymerizable compound. The alicyclic epoxy compound of formula (b), (A), (I) or (II) is used alone or in combination of at least two of them. When used in combination, the total amount of the alicyclic epoxy compound of formula (b), (A), (I) or (II) is preferably used in an amount described above, based on 100 parts by weight of cation-polymerizable compound.

The ink composition of this invention preferably contains an oxetane compound, together with the compound of formula (a-1) or (a-2) and the alicyclic epoxy compound of formula (b), (A), (I) or (II). Conventionally known oxetane compounds are usable but the use of an oxetane compound which is not substituted at the 2-position is preferred, thereby resulting in further enhanced sensitivity, enhanced physical property of cured film and enhanced adhesion of an image area onto the substrate.

Oxetane compounds which are substituted at the 2-position include, for example, a compound represented by the following formula (101): 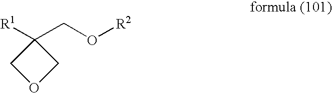
wherein R¹ is a hydrogen atom, an alkyl group having 1 to 6 carbon atoms (e.g., methyl, ethyl, propyl, butyl), a fluoroalkyl group having 1 to 6 carbon atoms, allyl group, an aryl group, a furyl group or a thienyl group; R² is an alkyl group having 1 to 6 carbon atoms (e.g., methyl, ethyl, propyl, butyl), an alkenyl group having 2 to 6 carbon atoms (e.g., 1-propenyl, 2-propenyl, 2-methyl-1-propenyl, 2-methyl-2-propenyl, 1-butenyl2-butenyl, 3-butenyl), an aromatic ring containing group (such as a phenyl group, a benzyl group, fluorobenzyl group, a methoxybenzyl group or a phenoxyethyl group), an alkylcarbonyl group having 2 to 6 carbon atoms (such as an ethylcarbonyl group, propylcarbonyl group or butylcarbonyl group), an alkoxycarbonyl group having 2 to 6 carbon atoms (such as an ethoxycarbonyl group, propoxycarbonyl group or butoxycarbonyl group), and a N-alkylcarbamoyl group having 2 to 6 carbon atoms (such as an ethylcarbamoyl group, propylcarbamoyl group, butylcarbamoyl group or pentylcarbamoyl group). Of oxetane compounds usable in this invention, a compound containing a single oxetane ring is preferred, resulting in a composition exhibiting superior adhesion and a low viscosity, leading to superior workability.

Compounds containing two oxetane rings include, for example, a compound represented by the following formula (102):

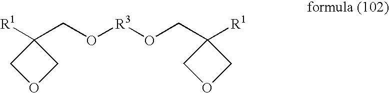

In the foregoing formula (102), R¹ is the same as defined in the foregoing formula (101); R³ is a linear or branched alkylene group (e.g., ethylene, propylene, butylenes), a linear or branched polyalkylene group (e.g., poly(ethylene) group, poly(propyleneoxy) group), a linear or branched unsaturated hydrocarbon group (e.g., propenylene group, methylpropenylene group, butenylene group), a carbonyl group or carbonyl group-containing alkylene group, a carboxyl group-containing alkylene group, or a carbamoyl group-containing alkylene group.

In the formula (102), R³ is a polyvalent group selected from group represented by the following formulas (103), (104) and (105): 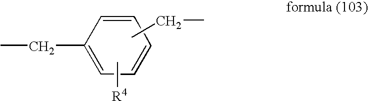
wherein R⁴ is a hydrogen atom, an alkyl group having 1 to 4 carbon atoms (e.g., methyl, ethyl, propyl, butyl), an alkoxy group having 1 to 4 carbon atom (e.g., methoxy, ethoxy, propoxy, butoxy), a halogen atom (e.g., chlorine atom, bromine atom), nitro group, cyano group, mercapto group, a lower alkylcarboxyl group, carboxyl group or a carbamoyl group; 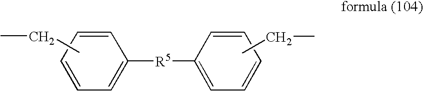
wherein R⁵ is an oxygen atom, a sulfur atom, methylene group, NH, SO, SO₂, C(CF₃)₂ or C(CH₃)₂; 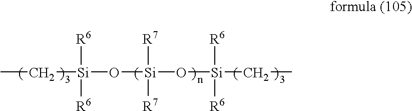
wherein R⁶ is an alkyl group having 1 to 4 carbon atoms (e.g., methyl, ethyl, propyl, butyl) or an aryl group; n is an integer of 0 to 2000; R⁷ is an alkyl group having 1 to 4 carbon atoms (e.g., methyl, ethyl, propyl, butyl) or an aryl group, and R⁷ also include a group represented by the following formula (106): 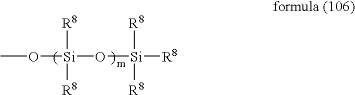
wherein R8 is an alkyl group having 1 to 4 carbon atoms (e.g., methyl, ethyl, propyl, butyl) or an aryl group; m is an integer of 0 to 100.

Specific examples of a compound containing two oxetane rings are shown below:

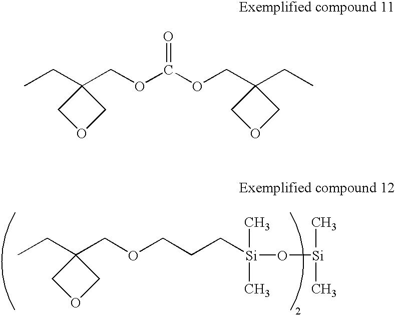

The exemplified compound 11 is one having R¹ of ethyl and R³ of carboxyl in the foregoing formula (102); the exemplified compound 12 is one having R¹ of ethyl in the foregoing formula (102) and R³ corresponding to R⁶ and R⁷ being methyl and n be in 1 in the foregoing formula (105).

In addition to the foregoing compounds, a preferred compound containing two oxetane rings is represented by the following formula (107): 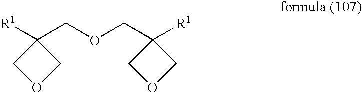
wherein R¹ is the same as defined in formula (101).

Compounds containing 3 or 4 oxetane rings include, for example, a compound represented by the following formula (108): 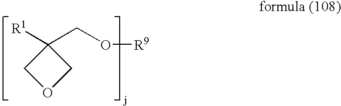
wherein R¹ is the same as defined in the foregoing formula (101); R⁹ is a branched alkylene group having 1 to 12 carbon atoms, for example, represented by the following formulas A to C, a branched poly(alkylene) group represented by the following formula D, or a branched polysiloxy group represented by the following formula E; j is 3 or 4:

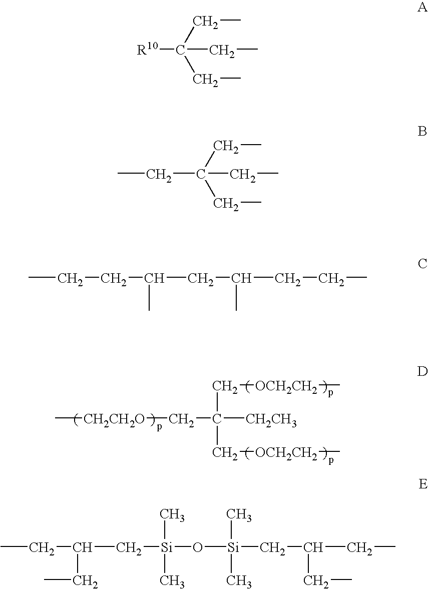

In the foregoing formula A, R¹⁰ is a lower alkyl group such as methyl, ethyl or propyl; in the formula D, p is an integer of 1 to 10.

Compounds containing 3 or 4 oxetane rings include, for example, compound 13, as shown below:

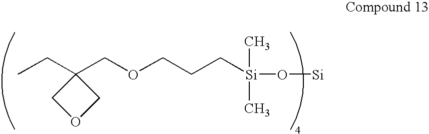

In addition to the foregoing, compounds containing 1 to 4 oxetane rings include, for example, a compound represented by the following formula (109): 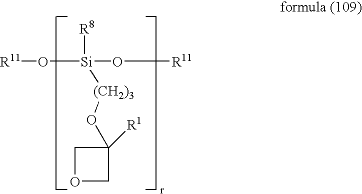
wherein R⁸ is the same as defined in the foregoing formula (106); R¹¹ is an alkyl group having 1 to 4 carbon atoms such as methyl, ethyl, propyl or butyl, or a trialkylsilyl group; r is an integer of 1 to 4.

Specific examples of preferred oxetane compounds include the following compounds:

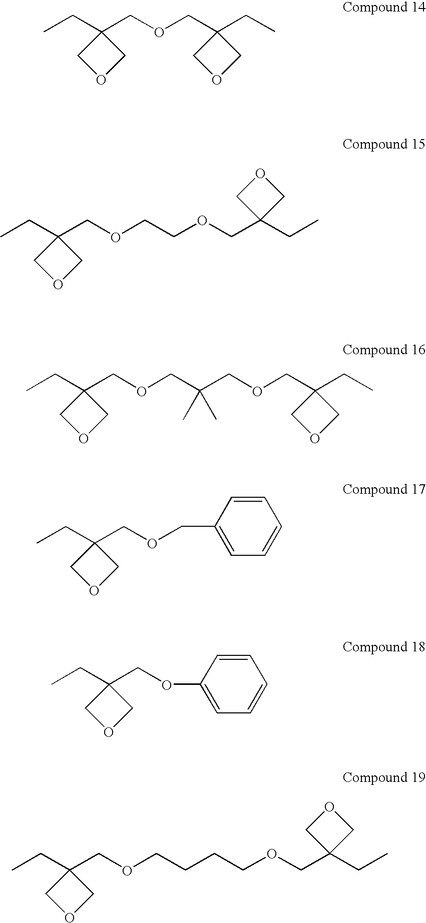

The oxetane ring-containing compounds described above can be prepared in accordance with methods known in the art, for example, oxetane ring synthesis from a diol, as disclosed in D. B. Pattison, J. Am. Chem. Soc., 3455, 79 (1957). In addition to the foregoing compounds, polymeric compounds having 1 to 4 oxetane rings and a molecular weight of 1,000 to 5,000 are also cited and specific examples thereof are shown below:

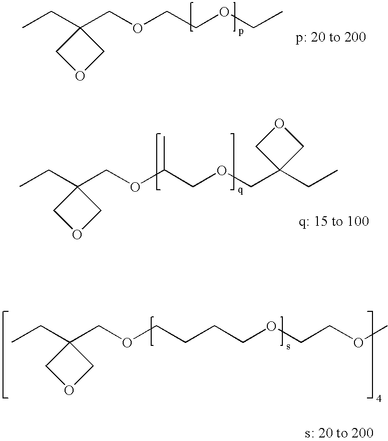

The oxetane compound is contained preferably in an amount of from 1 to 95 parts by weight, more preferably from 5 to 90 and still more preferably 30 to 90 parts by weight, based on 100 parts by weight of a cation-polymerizable compound. The oxetane compounds can be used alone or in combination. When two or more oxetane compounds are used in combination, the total amount of the oxetane compounds preferably falls within the above-mentioned range, based on 100 parts by weight of a cation-polymerizable compound.

The ink composition for ink jet printing may contain a vinyl compound. Examples of such a vinyl compound include di- or tri-vinyl ether compounds such as ethylene glycol divinyl ether, diethylene glycol divinyl ether; triethylene glycol divinyl ether, propylene glycol divinyl ether, dipropylene glycol divinyl ether, butanediol divinyl ether, hexanediol divinyl ether, cyclohexanediol divinyl ether, cyclohexanedimethanol divinyl ether, and trimethylolpropane trivinyl ether; and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexane vinyl ether, hydroxybutyl vinyl ether, 2-ethylhexyl vinyl ether, cyclohexanedimethanol monovinyl ether, n-propyl vinyl ether, isopropyl vinyl ether, isopropenylether-o-propylenecarbonate, dodecylvinyl ether, diethylene glycol monovinyl ether, and octadecyl vinyl ether.

Of these vinyl ether compounds, di- or tri-vinyl ether compounds are preferred in terms of curability, adhesion and surface hardness, and divinyl ether compounds are more preferred. The vinyl compounds may be used alone or in combination of them.

In the ink composition for ink jet printing of this invention, a photolytically acid-generating agent may be used, as shown below.

Photolytically acid-generation agents used in cationic polymerization type inks include, for example, compounds employed in chemical amplification type photoresist and compounds employed in cation photopolymerization, as described in “Imaging-Yo Yuuki Zairyo” (Organic Material for Imaging), edited by Yuuki Electronics Zairyo Kenkyukai, published by Bunshin Shupan (1993), page 187-192. Examples of suitable compounds in the invention are shown below.

The first group is B(C₆F₅)₄⁻, PF₆⁻, AsF₆⁻ or SbF₆⁻ salt, or a sulfonic acid salt such as p-CH₃C₆H₄SO₃⁻ or CF₃SO₃⁻ salt of aromatic onium compounds, such as diazonium, ammonium, iodonium, sulfonium and phosphonium. Compounds containing a borate ion or pF₆⁻ as a counter ion are preferred in terms of high acid-generating ability. Specific examples of onium compounds are shown below.

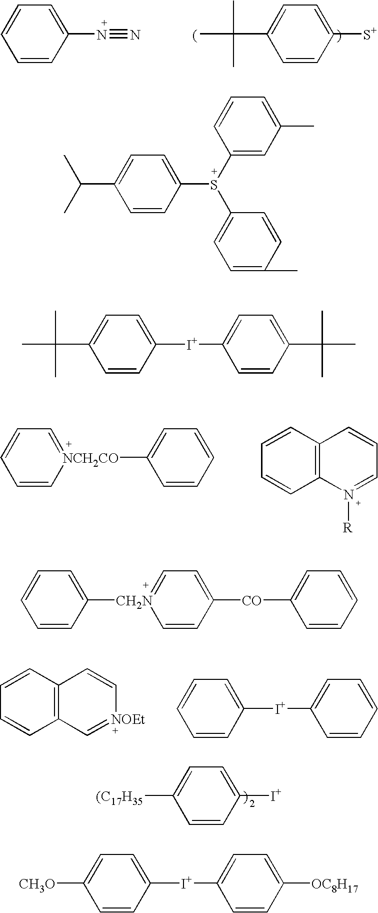

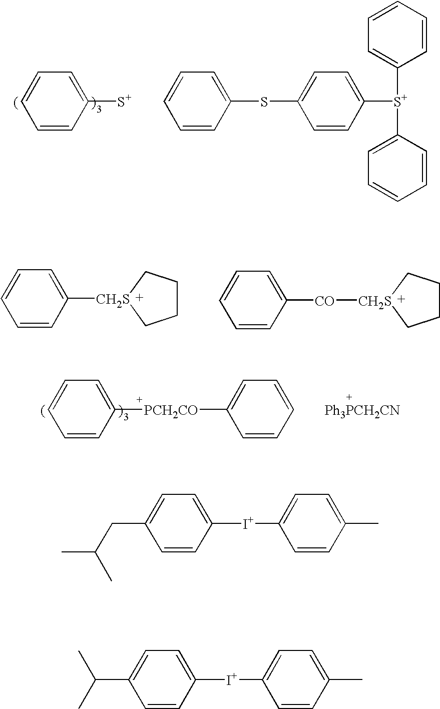

The second group is a sulfone compound generating sulfonic acid. Specific examples thereof are shown below.

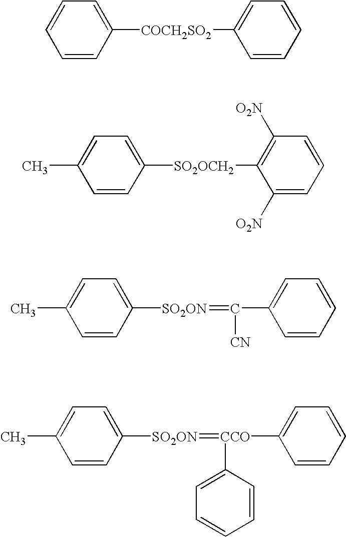

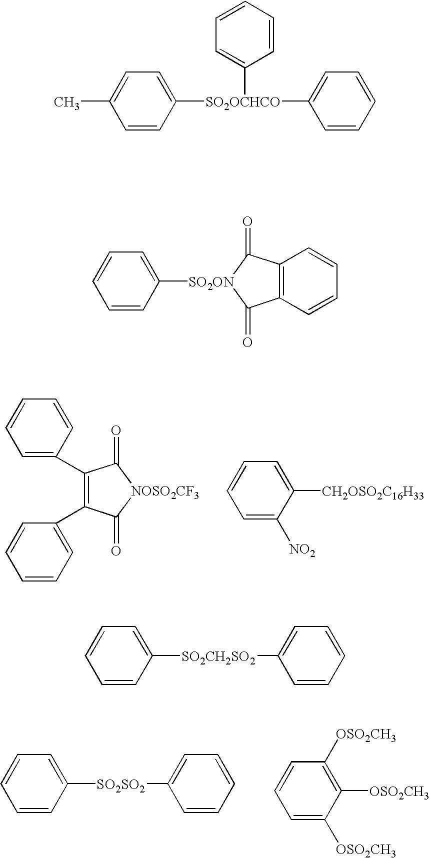

The third group is a halogen compound generating a hydrogen halide. Specific examples are shown below.

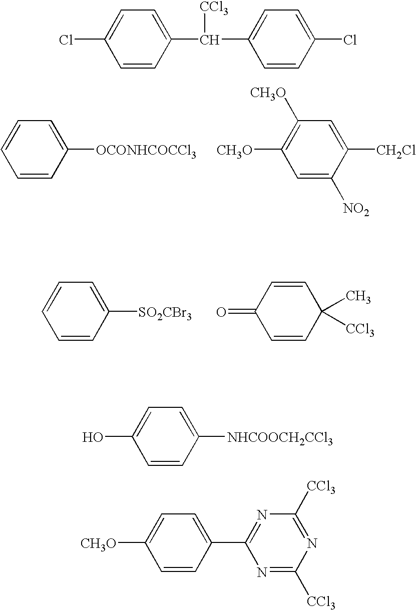

The fourth group is an iron arene complex. Specific examples thereof are shown below.

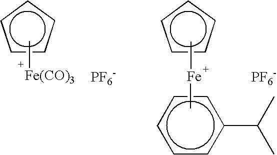

Cationic photopolymerization initiators usable in this invention include arylsulfonium salt derivatives (e.g., CYRACURE UVI-6990, CYRACURE UVI-6974, produced by Union Carbide Corp.; ADEKA OPTOMER SP-150, ADEKA OPTOMER SP-152, ADEKA OPTOMER SP-170, ADEKA OPTOMER SP-172, produced by ASAHI DENKA KOGYO K.K.), allyliodonium salt derivatives (e.g. RP-2074, produced by RHODIA Corp.), arene-ion complex derivatives (e.g., IRGACURE 261, produced by Ciba Geigy Corp.), diazonium salt derivatives, triazine type initiators and acid-generating agents such as other halides. The content of such cationic polymerization initiators is preferably from 0.2 to 20 parts by weight, based on 100 parts by weight of a cationic polymerizable compound. An initiator content of less than 0.2 parts by weight makes it difficult to achieve curing and a further enhanced curing effect cannot be achieved even when exceeding 20 parts by weight. These cationic photopolymerization initiators are usable by choosing one or more therefrom.

Preferred photolytically acid-generating agents usable in this invention are onium salts such a sulfonium salt, iodonium salt, ammonium salt and phosphonium salt and of these, a sulfonium salt compound is more preferred. Preferred sulfonium salts include those represented by the following formula (I-1), (I-2) and (I-3): 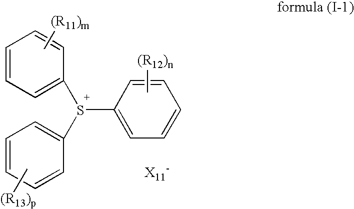
wherein R₁₁, R₁₂ and R₁₃ are each a substituent; m, n and p are each an integer of 0 to 5; X₁₁⁻ is a counter anion; 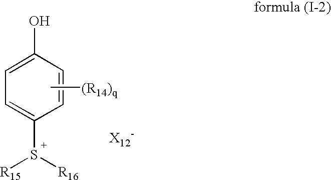
wherein R₁₄ is a substituent; q is an integer of 0 to 2; R₁₅ and R₁₆ are each a substituted or unsubstituted alkyl group, a substituted or unsubstituted alkenyl group, a substituted or unsubstituted alkynyl group or a substituted or unsubstituted aryl group; X₁₂⁻ is a counter anion; 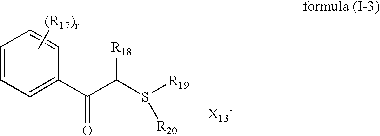
wherein R₁₇ is a substituent; r is an integer of 0 to 3; R₁₈ is a hydrogen atom or a substituted or unsubstituted alkyl group; R₁₉ and R₂₀ are each a substituted or unsubstituted alkyl group, a substituted or unsubstituted alkenyl group, a substituted or unsubstituted alkynyl group or a substituted or unsubstituted aryl group; X₁₃⁻ is a counter anion.

There will be described sulfonium salts represented by formulas (I-1), (I-2) and (I-3).

In formula (I-1), R₁₁, R¹² and R₁₃, each represents a substituent. Examples of a substituent include a halogen atom (e.g., fluorine atom, chlorine atom, bromine atom, iodine atom), an alkyl group having 1 to 6 carbon atoms (e.g., methyl, ethyl, propyl, isopropyl, butyl), a cycloalkyl group having 3 to 6 carbon atoms (e.g., cyclopropyl, cyclobutyl, cyclopentyl, cyclohexyl), an alkenyl group having 2 to 6 carbon atoms (e.g., vinyl, 1-propenyl, 2-propenyl, 2-butenyl), an alkynyl group having 2 to 6 carbon atoms (e.g., acetynyl, 1-propynyl, 2-propynyl, 2-butynyl) an alkoxy group having 1 to 6 carbon atoms (e.g., methoxy, ethoxy, n-propoxy, iso-propoxy, n-butoxy, tert-butoxy), an alkylthio group having 1 to 6 carbon atoms (e.g., methylthio, ethylthio, n-propylthio, iso-propylthio, n-butylthio, tert-butylthio), an aryl group having 6 to 14 carbon atoms (e.g., phenyl, naphthyl, anthracenyl), an aryloxy group having 6 to 10 carbon atoms (phenoxy, naphthoxy), an arylthio group having 6 to 10 carbon atoms (e.g., phenylthio, naphthylthio), an acyl group (e.g., acetyl, propionyl, trifluoroacetyl, benzoyl), an acyloxy group (e.g., acetoxy, propionyloxy, trifluoroacetoxy, benzoyloxy), an alkoxycarbonyl group (e.g., methoxycarbonyl, ethoxycarbonyl, tert-butoxycarbonyl), an aromatic heterocycle group having 4 to 8 carbon atoms (e.g., furyl, thienyl), nitro group, and cyano group. Of these substituents, a halogen atom, alkyl group, alkoxy group, aryl group, aryloxy group, arylthio group and acyl group are preferred. These substituents may further be substituted; and m, n and p are each an integer of 0 to 5, and preferably 1 or more.

X₁₁⁻ is a counter anion. Examples of a counter anion include a halogen atom (e.g., F⁻, Cl⁻, Br⁻), a complex ion (e.g., BF₄⁻, B(C₆F₅)₄⁻, PF₆⁻, AsF₆⁻, SbF₆⁻, GaF₆⁻), a benzenesulfonic acid ion (e.g., p-CH₃C₆H₄SO₃⁻, C₆H₅SO₃⁻), an alkylsulfonic acid ion (e.g., CH₃SO₃⁻, C₂H₅SO₃⁻), a fluoroalkylsulfonic acid ion (e.g., CF₃SO₃⁻, C₂F₅SO₃⁻, C₉F₁₉SO₃⁻). a fluorinated alkylbenzenesulfonic acid ion (e.g., p-CF₃—C₆H₄SO₃⁻, p-CF₃—C₆F₄SO₃⁻), a fluorinated benzenesulfonic acid ion (e.g., p-F—C₆H₄SO₃⁻, C₆F₅SO₃⁻). Of these, BF₄⁻, PF₆⁻, AsF₆⁻, SbF₆⁻, GaF₆⁻, B(C₆F₅)₄⁻, and a fluoroalkylsulfonic acid ion (e.g., CF₃SO₃⁻, C₂F₅SO₃⁻, C₉F₁₉SO₃⁻) are preferred, and BF₄⁻, PF₆⁻ and B(C₆F₅)₄⁻ are more preferred.

In formula (I-2), R₁₄ represents a substituent. Examples of a substituent include a halogen atom (e.g., fluorine atom, chlorine atom, bromine atom, iodine atom), an alkyl group having 1 to 6 carbon atoms (e.g., methyl, ethyl, propyl, isopropyl, butyl), a cycloalkyl group having 3 to 6 carbon atoms (e.g., cyclopropyl, cyclobutyl, cyclopentyl, cyclohexyl), an alkenyl group having 2 to 6 carbon atoms (e.g., vinyl, 1-propenyl, 2-propenyl, 2-butenyl), an alkynyl group having 2 to 6 carbon atoms (e.g., acetynyl, 1-propynyl, 2-propynyl, 2-butynyl) an alkoxy group having 1 to 6 carbon atoms (e.g., methoxy, ethoxy, n-propoxy, iso-propoxy, n-butoxy, tert-butoxy), an alkylthio group having 1 to 6 carbon atoms (e.g., methylthio, ethylthio, n-propylthio, iso-propylthio, n-butylthio, tert-butylthio), an aryl group having 6 to 14 carbon atoms (e.g., phenyl, naphthyl, anthracenyl), an aryloxy group having 6 to 10 carbon atoms (phenoxy, naphthoxy), an arylthio group having 6 to 10 carbon atoms (e.g., phenylthio, naphthylthio), an acyl group (e.g., acetyl, propionyl, trifluoroacetyl, benzoyl), an acyloxy group (e.g., acetoxy, propionyloxy, trifluoroacetoxy, benzoyloxy), an alkoxycarbonyl group (e.g., methoxycarbonyl, ethoxycarbonyl, tert-butoxycarbonyl), an aromatic heterocycle group having 4 to 8 carbon atoms (e.g., furyl, thienyl), nitro group, cyano group and hydroxyl group. Of these substituents, a halogen atom, alkyl group, aryl group, alkoxy group and aryloxy group are preferred. These substituents may be further substituted.

In formula (I-2), q is an integer of 0 to 2, preferably 1 or more, and more preferably 2. R₁₅ and R₁₆ are each a substituted or unsubstituted alkyl group, a substituted or unsubstituted alkenyl group, a substituted or unsubstituted alkynyl group or a substituted or unsubstituted aryl group. Examples of a substituent include a halogen atom (e.g., fluorine atom, chlorine atom, bromine atom, iodine atom), an alkyl group having 1 to 6 carbon atoms (e.g., methyl, ethyl, propyl, isopropyl, butyl), a cycloalkyl group having 3 to 6 carbon atoms (e.g., cyclopropyl, cyclobutyl, cyclopentyl, cyclohexyl), an alkenyl group having 2 to 6 carbon atoms (e.g., vinyl, 1-propenyl, 2-propenyl, 2-butenyl), an alkynyl group having 2 to 6 carbon atoms (e.g., acetynyl, 1-propynyl, 2-propynyl, 2-butynyl) an alkoxy group having 1 to 6 carbon atoms (e.g., methoxy, ethoxy, n-propoxy, iso-propoxy, n-butoxy, tert-butoxy), an alkylthio group having 1 to 6 carbon atoms (e.g., methylthio, ethylthio, n-propylthio, iso-propylthio, n-butylthio, tert-butylthio), an aryl group having 6 to 14 carbon atoms (e.g., phenyl, naphthyl, anthracenyl), an aryloxy group having 6 to 10 carbon atoms (phenoxy, naphthoxy), an arylthio group having 6 to 10 carbon atoms (e.g., phenylthio, naphthylthio), an acyl group (e.g., acetyl, propionyl, trifluoroacetyl, benzoyl), an acyloxy group (e.g., acetoxy, propionyloxy, trifluoroacetoxy, benzoyloxy), an alkoxycarbonyl group (e.g., methoxycarbonyl, ethoxycarbonyl, tert-butoxycarbonyl), an aromatic heterocycle group having 4 to 8 carbon atoms (e.g., furyl, thienyl), nitro group, cyano group and hydroxyl group. Of these substituents, a halogen atom, alkyl group, alkyloxy group, aryl group, aryloxy group, arylthio group and acyl group are preferred. R₁₅ and R₁₆ preferably are each a substituted or unsubstituted alkyl group, or a substituted or unsubstituted aryl group and the substituent is a halogen atom, alkyl group, alkoxy group, aryl group, aryloxy group, acyl group or hydroxyl group.

X₁₂⁻ is a counter anion. Examples of a counter anion include a halogen atom (e.g., F⁻, Cl⁻, Br⁻), a complex ion (e.g., BF₄⁻, B(C₆F₅)₄⁻, PF₆⁻, AsF₆⁻, SbF₆⁻, GaF₆⁻), a benzenesulfonic acid ion (e.g., p-CH₃C₆H₄SO₃⁻, C₆H₅SO₃⁻), an alkylsulfonic acid ion (e.g., CH₃SO₃⁻, C₂H₅SO₃⁻), a fluoroalkylsulfonic acid ion (e.g., CF₃SO₃⁻, C₂F₅SO₃⁻, C₉F₁₉SO₂⁻). a fluorinated alkylbenzenesulfonic acid ion (e.g., p-CF₃—C₆H₄SO₃⁻, p-CF₃—C₆F₄SO₃⁻), a fluorinated benzenesulfonic acid ion (e.g., p-F—C₆H₄SO₃⁻, C₆F₅SO₃⁻). Of these, BF₄⁻, PF₆⁻, AsF₆⁻, SbF₆⁻, GaF₆⁻, B(C₆F₅)₄⁻, and a fluoroalkylsulfonic acid ion (e.g., CF₃SO₃⁻, C₂F₅SO₃⁻, C₉F₁₉SO₃⁻) are preferred, and BF₄⁻, PF₆⁻ and B(C₆F₅)₄⁻ are more preferred.

In formula (I-3), R₁₇ represents a substituent. Examples of a substituent include a halogen atom (e.g., fluorine atom, chlorine atom, bromine atom, iodine atom), an alkyl group having 1 to 6 carbon atoms (e.g., methyl, ethyl, propyl, isopropyl, butyl), a cycloalkyl group having 3 to 6 carbon atoms (e.g., cyclopropyl, cyclobutyl, cyclopentyl, cyclohexyl), an alkenyl group having 2 to 6 carbon atoms (e.g., vinyl, 1-propenyl, 2-propenyl, 2-butenyl), an alkynyl group having 2 to 6 carbon atoms (e.g., acetynyl, 1-propynyl, 2-propynyl, 2-butynyl) an alkoxy group having 1 to 6 carbon atoms (e.g., methoxy, ethoxy, n-propoxy, iso-propoxy, n-butoxy, tert-butoxy), an alkylthio group having 1 to 6 carbon atoms (e.g., methylthio, ethylthio, n-propylthio, iso-propylthio, n-butylthio, tert-butylthio), an aryl group having 6 to 14 carbon atoms (e.g., phenyl, naphthyl, anthracenyl), an aryloxy group having 6 to 10 carbon atoms (phenoxy, naphthoxy), an arylthio group having 6 to 10 carbon atoms (e.g., phenylthio, naphthylthio), an acyl group (e.g., acetyl, propionyl, trifluoroacetyl, benzoyl), an acyloxy group (e.g., acetoxy, propionyloxy, trifluoroacetoxy, benzoyloxy), an alkoxycarbonyl group (e.g., methoxycarbonyl, ethoxycarbonyl, tert-butoxycarbonyl), an aromatic heterocycle group having 4 to 8 carbon atoms (e.g., furyl, thienyl), nitro group and cyano group. Of these substituents, a halogen atom, alkyl group, alkoxy group, aryl group, aryloxy group and acyl group are preferred.

In formula (I-3), r is an integer of 0 to 3, preferably 1 or more, and more preferably 2. R₁₈ is a substituted or unsubstituted alkyl group, and R₁₉ and R₂₀ are each a substituted or unsubstituted alkyl group, a substituted or unsubstituted alkenyl group, a substituted or unsubstituted alkynyl group or a substituted or unsubstituted aryl group. Examples of a substituent include a halogen atom (e.g., fluorine atom, chlorine atom, bromine atom, iodine atom), an alkyl group having 1 to 6 carbon atoms (e.g., methyl, ethyl, propyl, isopropyl, butyl), a cycloalkyl group having 3 to 6 carbon atoms (e.g., cyclopropyl, cyclobutyl, cyclopentyl, cyclohexyl), an alkenyl group having 2 to 6 carbon atoms (e.g., vinyl, 1-propenyl, 2-propenyl, 2-butenyl), an alkynyl group having 2 to 6 carbon atoms (e.g., acetynyl, 1-propynyl, 2-propynyl, 2-butynyl) an alkoxy group having 1 to 6 carbon atoms (e.g., methoxy, ethoxy, n-propoxy, iso-propoxy, n-butoxy, tert-butoxy), an alkylthio group having 1 to 6 carbon atoms (e.g., methylthio, ethylthio, n-propylthio, iso-propylthio, n-butylthio, tert-butylthio), an aryl group having 6 to 14 carbon atoms (e.g., phenyl, naphthyl, anthracenyl), an aryloxy group having 6 to 10 carbon atoms (phenoxy, naphthoxy), an arylthio group having 6 to 10 carbon atoms (e.g., phenylthio, naphthylthio), an acyl group (e.g., acetyl, propionyl, trifluoroacetyl, benzoyl), an acyloxy group (e.g., acetoxy, propionyloxy, trifluoroacetoxy, benzoyloxy), an alkoxycarbonyl group (e.g., methoxycarbonyl, ethoxycarbonyl, tert-butoxycarbonyl), an aromatic heterocycle group having 4 to 8 carbon atoms (e.g., furyl, thienyl), nitro group, cyano group and hydroxyl group. Of these substituents, a halogen atom, alkyl group, alkyloxy group, aryl group, aryloxy group, arylthio group and acyl group are preferred. R₁₅ is preferably a hydrogen atom or an unsubstituted lower alkyl group (e.g., methyl, ethyl, propyl); R₁₉ and R₂₀ preferably are each a substituted or unsubstituted alkyl group, or a substituted or unsubstituted aryl group and the preferred substituent is a halogen atom, alkyl group, alkoxy group, aryl group, aryloxy group or acyl group.

X₁₃⁻ is a counter anion. Examples of a counter anion include a halogen atom (e.g., F⁻, Cl⁻, Br⁻), a complex ion (e.g., BF₄⁻, B(C₆F₅)₄⁻, PF₆⁻, AsF₆⁻, SbF₆⁻, GaF₆⁻), a benzenesulfonic acid ion (e.g., p-CH₃C₆H₄SO₃⁻, C₆H₅SO₃⁻), an alkylsulfonic acid ion (e.g., CH₃SO₃⁻, C₂H₅SO₃⁻), a fluoroalkylsulfonic acid ion (e.g., CF₃SO₃⁻, C₂F₅SO₃⁻, C₉F₁₉SO₃⁻). a fluorinated alkylbenzenesulfonic acid ion (e.g., p-CF₃—C₆H₄SO₃⁻, p-CF₃—C₆F₄SO₃⁻), a fluorinated benzenesulfonic acid ion (e.g., p-F—C₆H₄SO₃⁻, C₆F₅SO₃⁻). Of these, PF₆⁻, BF₄⁻, SbF₆⁻, GaF₆⁻, AsF₆⁻, B(C₆F₅)₄⁻, and a fluoroalkylsulfonic acid ion (e.g., CF₃SO₃⁻, C₂F₅SO₃⁻, C₉F₁₉SO₃⁻) are preferred, and BF₄⁻, B(C₆F₅)₄⁻ and PF₆⁻ are more preferred.

Specific examples of sulfonium salts of formulas (I-1), (I-2) and (I-3) are shown below but this invention is not limited to these.

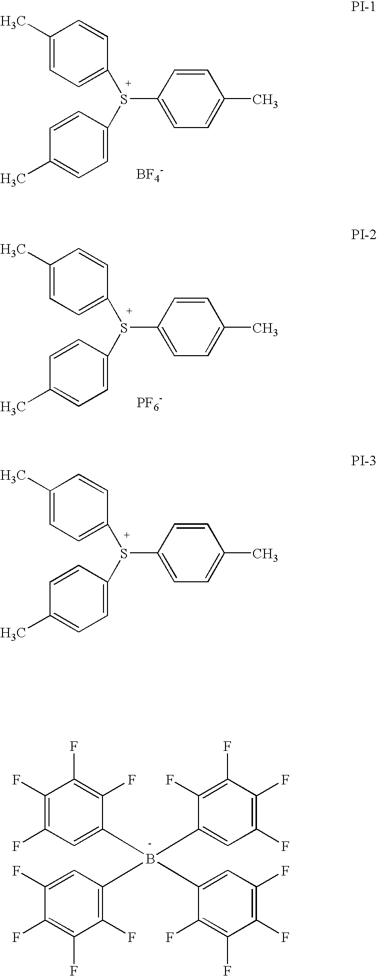

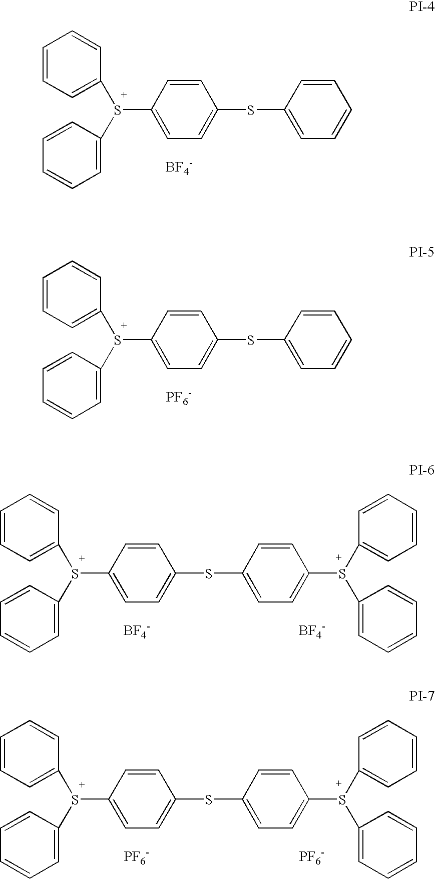

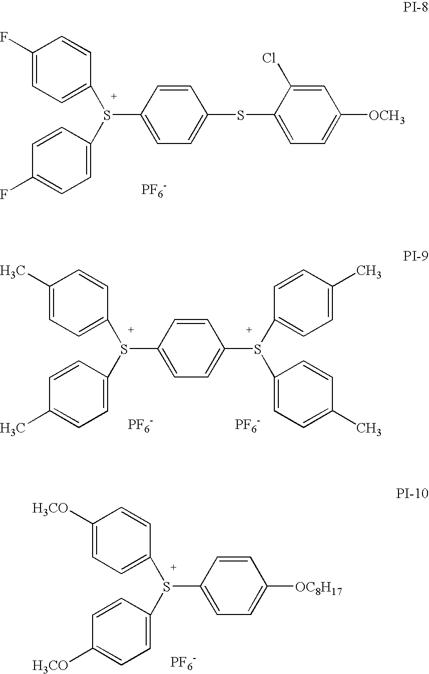

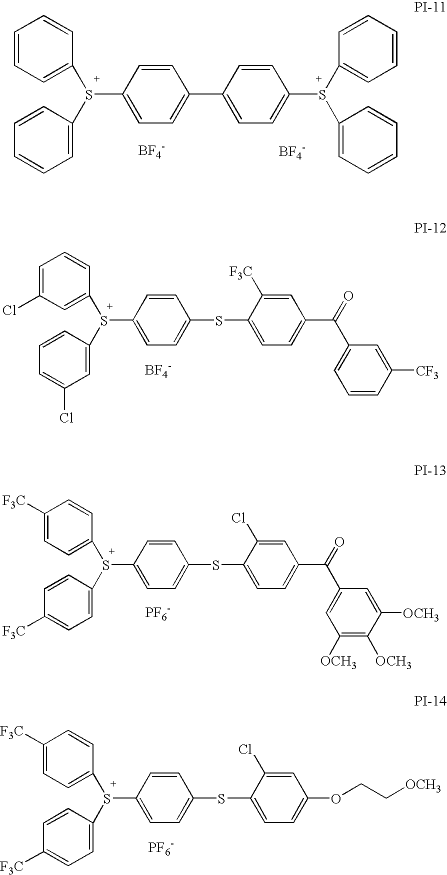

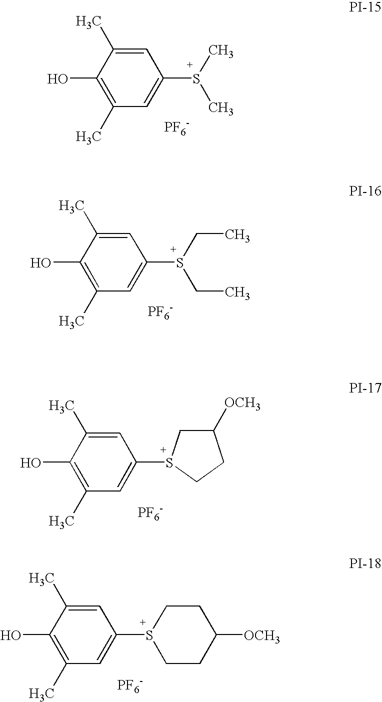

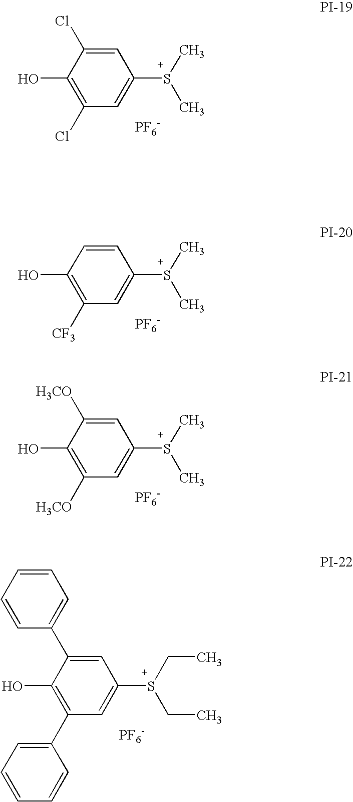

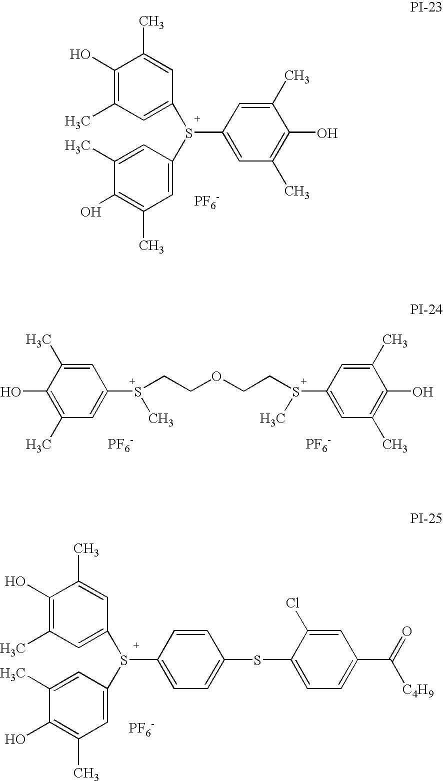

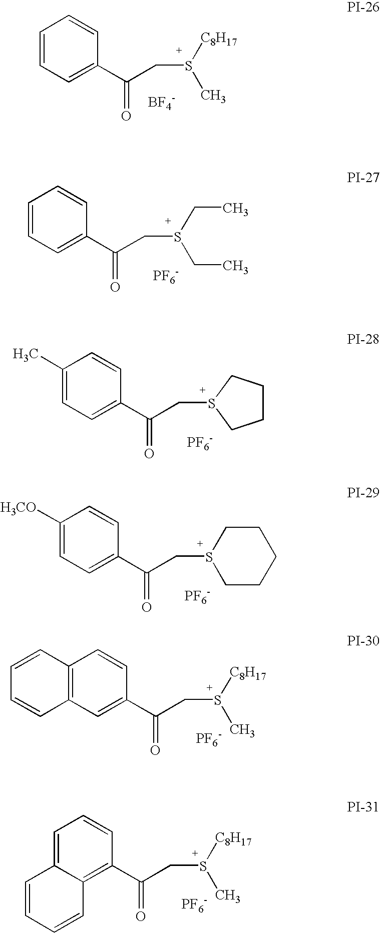

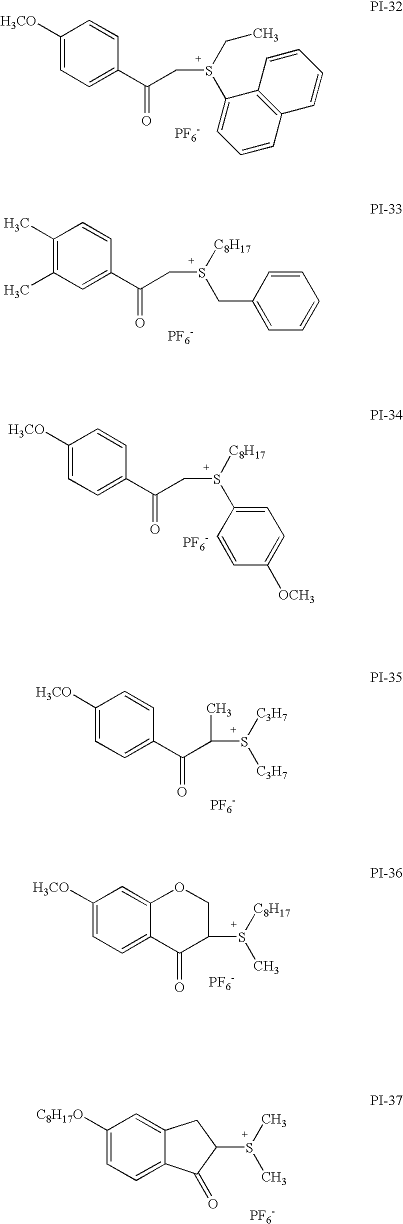

The sulfonium salts of formula (I-1) are preferably represented by the following formula (T-1): 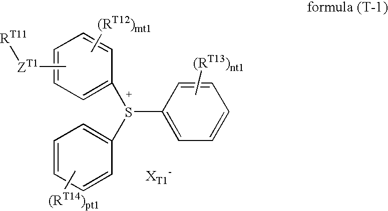
wherein R^{T11} and R^{T12} are each an alkyl group or an aromatic group; Z is an oxygen atom or sulfur atom; R^{T13} and R^{T14} are each an alkyl group, aromatic group, alkoxy group, aryloxy group, alkylthio group or arylthio group; mt1 is an integer of 0 to 4, nt1 and pt1 are each an integer of 1 to 5; X_{T1} is a counter anion.

There will be described sulfonium salts of formula (T-1). In formula (T-1), R^{T11} and R^{T12} are each an alkyl group or an aromatic group and the alkyl group may be straight or branched, or cyclic and examples thereof include methyl, ethyl, propyl, isopropyl, tert-butyl, pentyl, hexyl, octyl, dodecyl, tridecyl, tetradecy; pentadecyl cyclopentyl and cyclohexyl. The aromatic group may be an aromatic hydrocarbon group or an aromatic heterocyclic group, which may be a condensed ring, and examples thereof include an aromatic hydrocarbon group (e.g., phenyl, naphthyl), and an aromatic heterocyclic group (e.g., furyl, thienyl, pyridyl, pyridazyl, pyrimidyl, pyrazyl, triazyl, imidazolyl, pyrazolyl, thiazolyl, benzoimidazolyl, benzooxazilyl, quinazolyl, phthalzyl).

The foregoing alkyl group and aromatic group may further substituted by substituent(s), and plural substituents may combine with each other to form a ring which may be condensed. Examples of such a substituent include, an alkyl group described above, an alkenyl group (e.g., vinyl, allyl), an alkynyl group (e.g., ethynyl, propargyl), an aromatic hydrocarbon group (e.g., phenyl. naphthyl), an aromatic heterocyclic group (e.g., furyl, thienyl, pyridyl, pyridazyl, pyrimidyl, pyrazyl, triazyl, imidazolyl, pyrazolyl, thiazolyl, benzoimidazolyl, benzooxazolyl, quinazolyl, phthalazyl), and a heterocyclic group (e.g., pyrrolidyl, imidazolidyl, morpholyl group, oxazolidyl), an alkoxy group (e.g., methoxy, ethoxy, propyloxy, pentyloxy, hexyloxy, octyloxy, dodecyloxy), a cycloalkoxy group (e.g., cyclopentyloxy, cyclohexyloxy), an aryloxy group (e.g., phenoxy, naphthyloxy), an alkylthio group (e.g., methylthio, ethylthio, propylthio, pentylthio, hexylthio, octylthio, dodecylthio), a cycloalkylthio group (e.g., cyclopentylthio, cyclohexylthio), an arylthio group (e.g., phenylthio, naphthylthio), an alkoxycarbonyl group (e.g., methyloxycarbonyl, ethyloxycarbonyl, butyloxycarbonyl, octyloxycarbonyl, dodecyloxycarbonyl), an aryloxycarbonyl group (e.g., phenyloxycarbonyl, naphthyloxycarbonyl), a sulfamoyl group (e.g., aminosulfonyl, methylaminosulfonyl, dimethylaminosulfonyl, butylaminosulfonyl, hexylaminosufonyl, cyclohexylaminosulfonyl, octylaminosulfonyl, dodecylaminosulfonyl, phenylaminosulfonyl, naphthylaminosulfonyl, 2-pyridylaminosulfonyl), an acyl group (e.g., acetyl, ethylcarbonyl, propylcarbonyl, pentylcarbonyl, cyclohexylcarbonyl, octylcarbonyl, 2-ethylhexylcarbonyl, dodecylcarbonyl, phenylcarbonyl, naphthylcarbonyl, pyridylcarbonyl), an acyloxy group (e.g., acetyloxy, ethylcarbonyloxy, butylcarbonyloxy, octylcarbonyloxy, dodecylcarbonyloxy, phenylcarbonyloxy), an amido group (e.g., methylcarbonylamino, ethylcarbonylamino, dimethylcarbonylamino, propylcarbonylamino, pentylcarbonylamino, cyclohexylcarbonylamino, 2-ethylhexylcarbonylamino, octylcarbonylamino, dodecylcarbonylamino, phenylcarbonylamino, naphthylcarbonylamino), a carbamoyl group (e.g., aminocarbonyl, methylaminocarbonyl, dimethylaminocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl, naphthylaminocarbonyl, 2-pyridylaminocarbonyl), a ureido group (e.g., methylureido, ethylureido, pentylureido, cyclohexylureido, octylureido, dodecylureido, phenylureido, naphthylureido, 2-pyridylureido), a sufinyl group (e.g., methylsulfinyl, ethylsulfinyl, butylsulfinyl, cyclohexylsulfinyl, 2-ethylhexylsulfinyl, dodecysulfinyl, phenylsufinyl, naphthylsulfinyl, 2-pyridylsulfiny), an alkylsulfonyl group (e.g., methylsulfinyl, ethylsulfinyl, butylsulfinyl, cyclohexylsulfinyl, 2-ethylhexylsulfinyl, dodecylsufinyl), an arylsulfonyl group (e.g., phenylsulfonyl, naphthylsulfonyl, 2-pyridylsulfonyl), an amino group (e.g., amino, ethylamino, dimethylamino, butylamino, cyclopentylamino, 2-ethylhexylamino, dodecylamino, anilino, naphthylamine, 2-pyridylamino), a halogen atom (e.g., fluorine atom, chlorine atom, bromine atom), a fluorohydrocarbon group (e.g., fluoromethyl, trifluoromethyl, pentafluoroethyl, pentafluorophenyl), cyano group, nitro group, hydroxyl group, mercapto group, and a silyl group (e.g., trimethylsilyl, triisopropylsilyl, triphenylsilyl, phenyldiethylsilyl).

These substituents may be further substituted by substituents described above, and plural substituents may combine with each other to form a ring. The alkyl group or aromatic group represented by R^{T1} or R^{T2}, which may be substituted, is preferably an unsubstituted alkyl or aromatic group, or a halogen atom-substituted alkyl or an alkoxy group-substituted aromatic group, and more preferably an unsubstituted alkyl or aromatic group, or fluorine atom-substituted alky or alkoxy group-substituted aromatic group. Examples of a fluorine atom-substituted alkyl group include fluoromethyl, trifluoromethyl, pentafluoroethyl and pentafluorophenyl.

Z^{T1} is an oxygen or sulfur atom, and Z^{T1} is preferably bonded to the ortho or para position (more preferably para position) of a benzene ring bonded to the sulfonium ion. R^{T13} and R^{T14} are each an alkyl group, aromatic group, alkoxy group, aryloxy group, alkylthio group or arylthio group, and the alkyl group and aromatic group are the same as defined in the foregoing R^{T11} and R^{T12}, the alkoxy and the aryloxy group are respectively oxygen-bonded alkyl and aryl group which are the same as defined in the foregoing R^{T11} and R^{T12}, and including, for example, an alkoxy group (e.g., methoxy, ethox, propyloxy, pentyloxy, hexyloxy, octyloxy, dodecyloxy, fluoromethyl, trifluoromethyl, pentafluoroethyl, pentafluorophenyl), cycloalkoxy group (e.g., cyclopentyloxy, cyclohexyloxy), and aryloxy group (e.g., phenoxy, naphthoxy); the alkylthio and the arylthio group are respectively sulfur-bonded alkyl and aryl group which are the same as defined in the foregoing R^{T11} and R^{T12}, and including, for example, an alkylthio group (e.g., methylthio, ethylthio, propylthio, pentylthio, hexylthio, octylthio, dodecylthio), cycloalkylthio group (e.g., cyclopentylthio, cyclohexylthio) and arylthio group (e.g., phenylthio, naphthylthio).

The aromatic group, aryloxy group and arylthio group described above may be a condensed ring. The alkyl group, aromatic group, alkoxy group, aryloxy group, alkylthio group and arylthio group each may be substituted, in which plural substituents may combine with each other to form a ring or a condensed ring, and examples of such substituents are the same as examples of substituents for R^{T11}. These substituents may be further substituted by substituents, and the substituents may combine with each other to form a ring. The alkyl group, aromatic group, alkoxy group, aryloxy group, alkylthio group and arylthio group of R^{T13} and R^{T14} may be substituted by a substituents, but unsubstituted alkyl, aromatic, alkoxy, aryloxy, alkylthio and arylthio groups, or a halogen-substituted alkyl and alkoxy-substituted aromatic groups are preferred; and unsubstituted alkyl, aromatic, alkoxy, aryloxy, alkylthio and arylthio groups, or fluorine-substituted alkyl and alkoxy-substituted aromatic groups are more preferred. Examples of a fluorine-substituted alkyl group include fluoromethyl, trifluoromethyl, pentafluoroethyl and pentafluorophenyl.

In formula (T-1), mt1 is an integer of 0 to 4, preferably from 0 to 3, and more preferably from 0 to 2; nt1 and pt1 are each an integer of 1 to 5, preferably from 1 to 3, and more preferably from 1 to 2. Plural R^{T12}, R^{T13} and R^{T14} may be the same or different, respectively; R^{T11} and R^{T12}, or plural R_{T12}s may combine with each other to form a ring, R^{T12} and R^{T13}, or plural R^{T13}s may combine with each other to form a ring, and R^{T12} and R^{T14}, or plural R^{T14}s may combine with each other to form a ring. At least one R^{T13} is preferably bonded to the ortho or para position (more preferably para position) of the benzene ring bonded to sulfonium ion. At least one R^{T14} is preferably bonded to the ortho or para position (more preferably para position) of the benzene ring bonded to sulfonium ion.

X_{T1}⁻ is a counter anion and examples of such a counter anion include a halogen atom (e.g., F⁻, Cl⁻, Br⁻), a complex ion (e.g., BF₄⁻, B(C₆F₅)₄⁻, PF₆⁻, AsF₆⁻, SbF₆⁻, GaF₆⁻), a benzenesulfonic acid ion (e.g., p-CH₃C₆H₄SO₃⁻, C₆H₅SO₃⁻), an alkylsulfonic acid ion (e.g., CH₃SO₃⁻, C₂H₅SO₃⁻), a fluoroalkylsulfonic acid ion (e.g., CF₃SO₃⁻, C₂F₅SO₃⁻, C₉F₁₉SO₃⁻). a fluorinated alkylbenzenesulfonic acid ion (e.g., p-CF₃—C₆H₄SO₃⁻, p-CF₃—C₆F₄SO₃⁻), a fluorinated benzenesulfonic acid ion (e.g., p-F—C₆H₄SO₃⁻, C₆F₅SO₃⁻). Of these, PF₆⁻, BF₄⁻, SbF₆⁻, GaF₆⁻, AsF₆⁻, B(C₆F₅)₄⁻, and a fluoroalkylsulfonic acid ion (e.g., CF₃SO₃⁻, C₂F₅SO₃⁻, C₉F₁₉SO₃⁻) are preferred, and BF₄⁻, B(C₆F₅)₄⁻ and PF₆⁻ are more preferred.

Specific examples of sulfonium salts represented by formula (T-1) are shown below but are by no means limited to these.

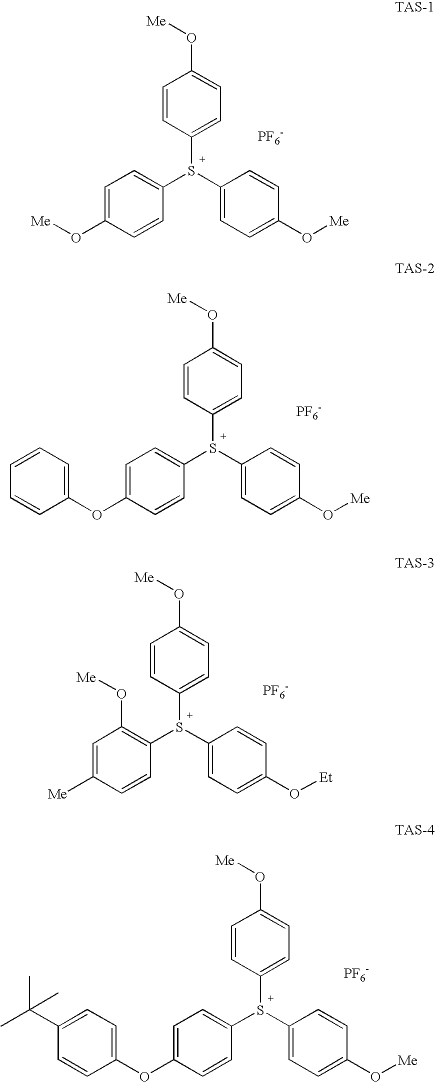

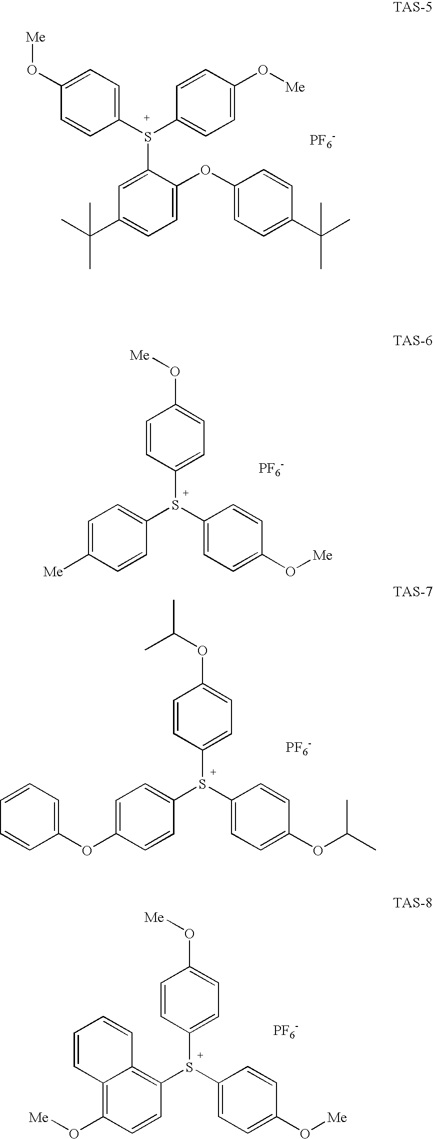

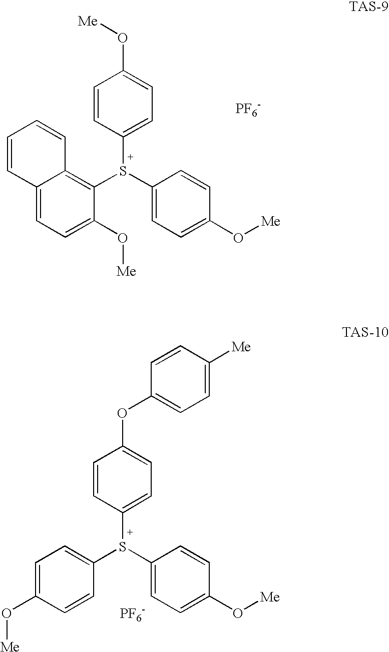

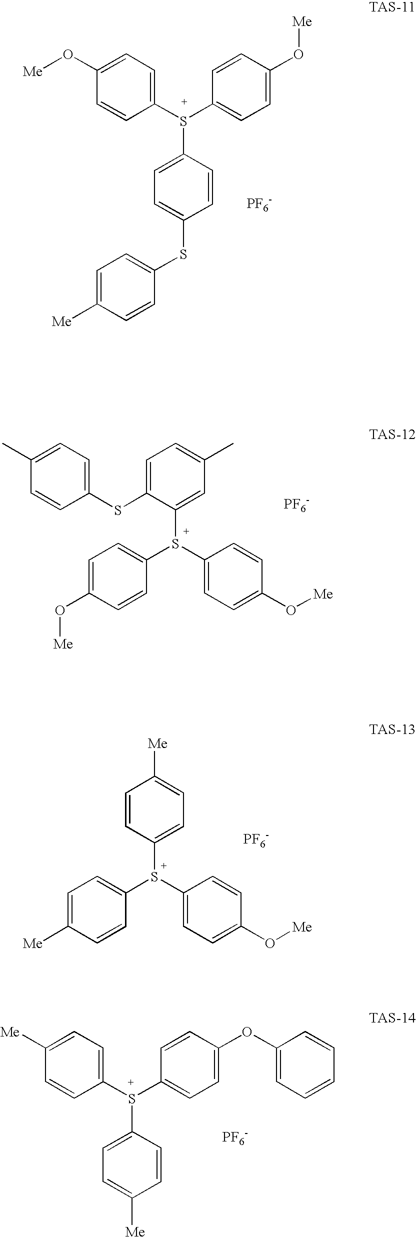

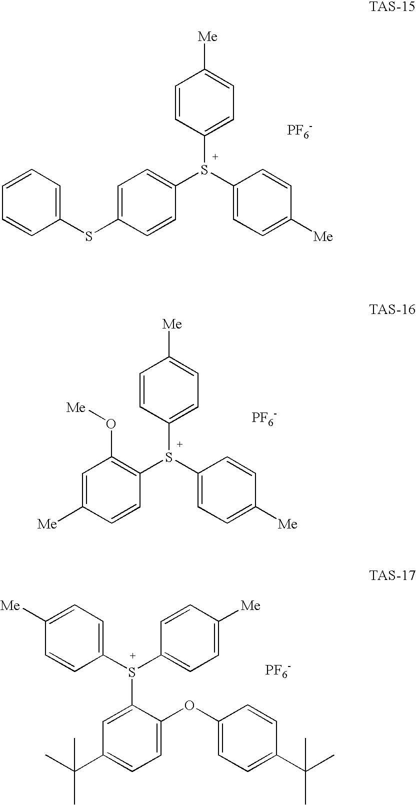

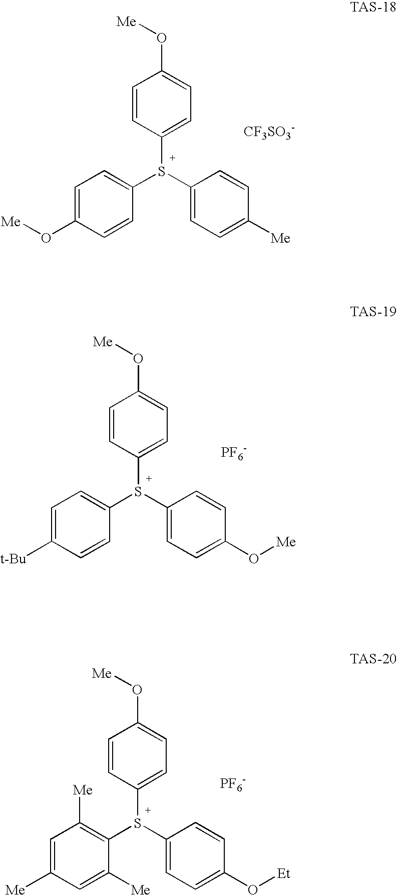

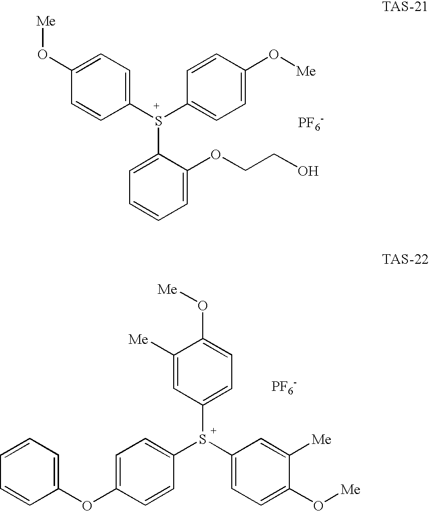

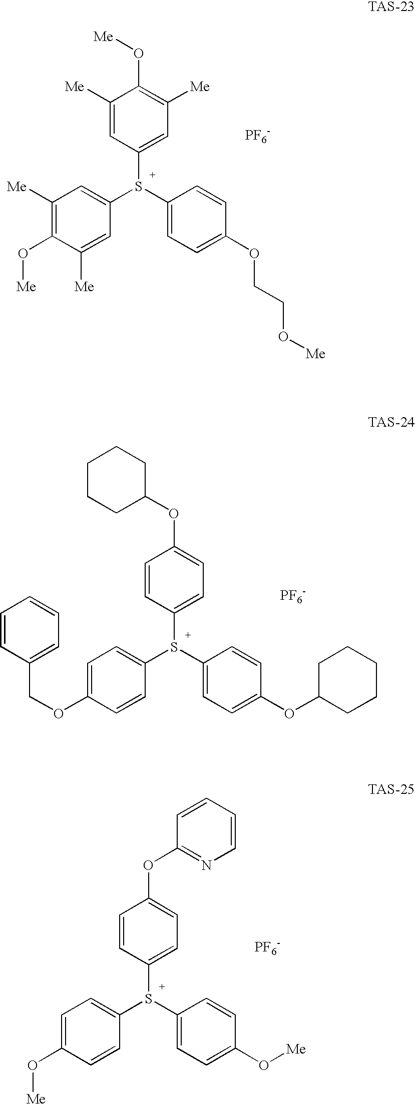

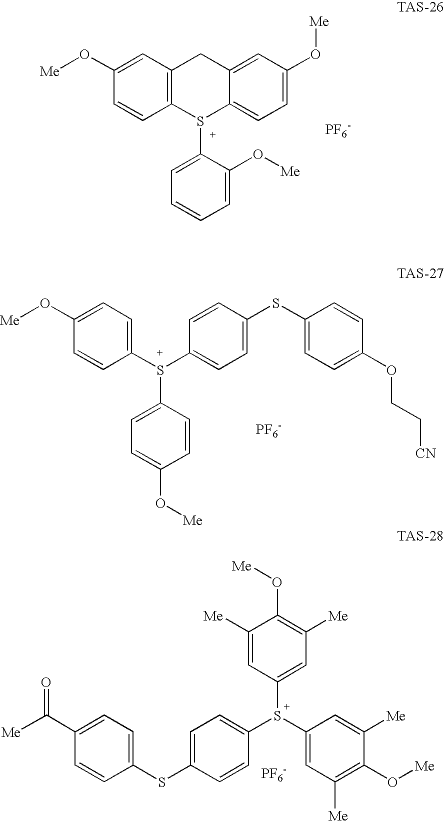

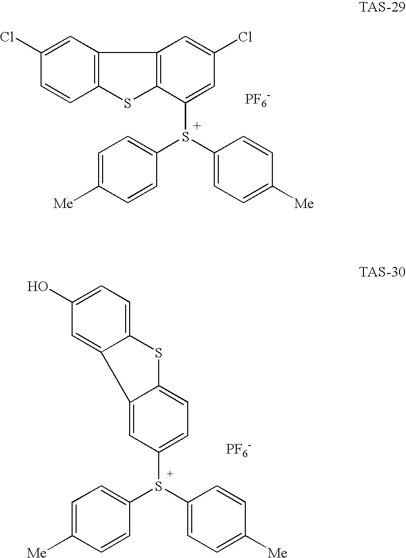

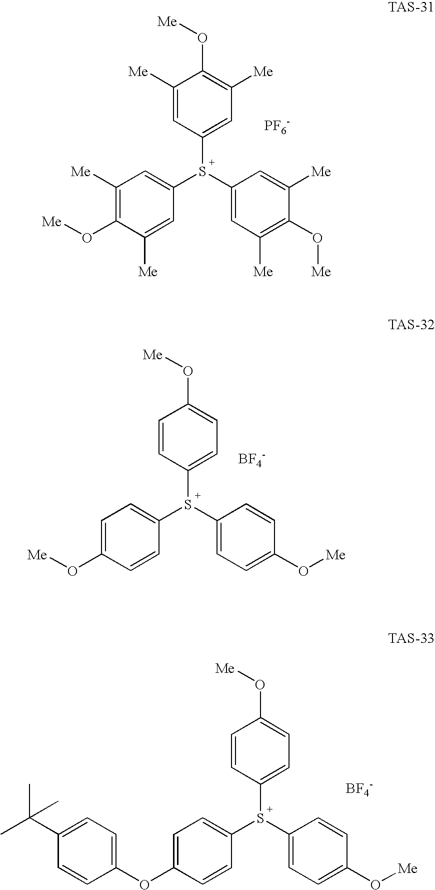

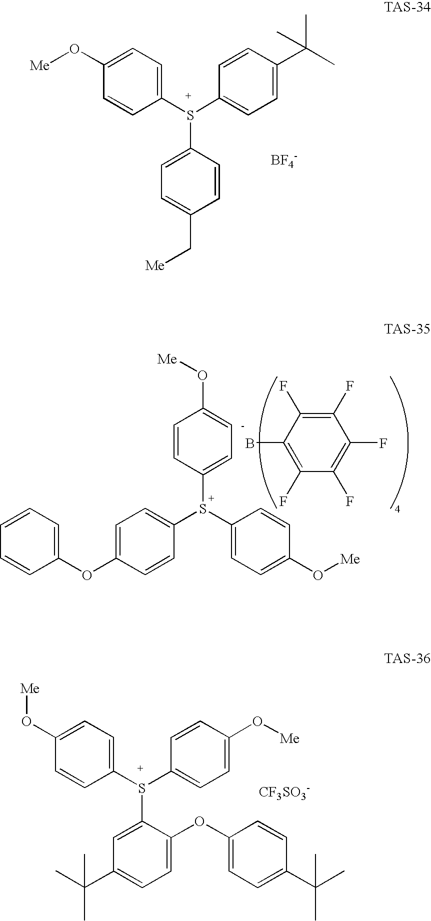

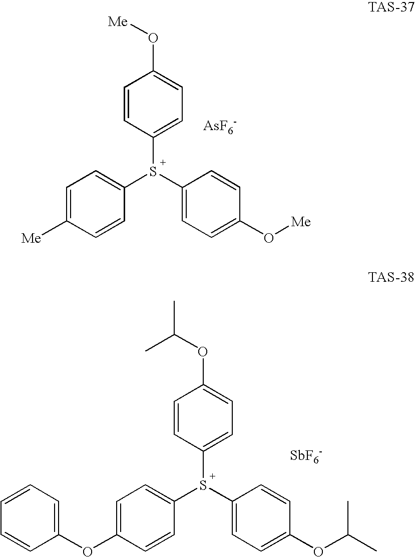

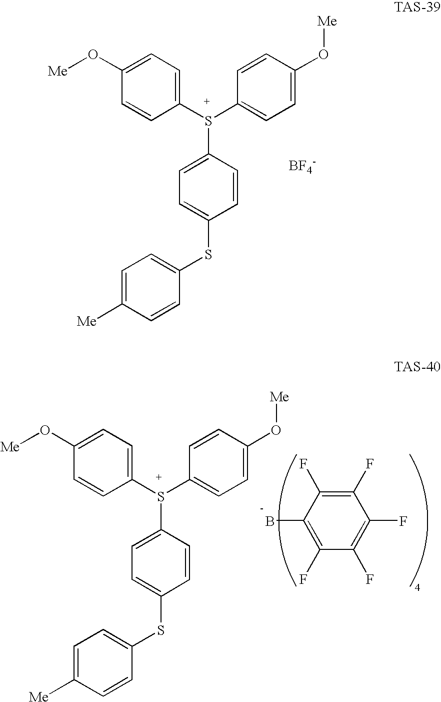

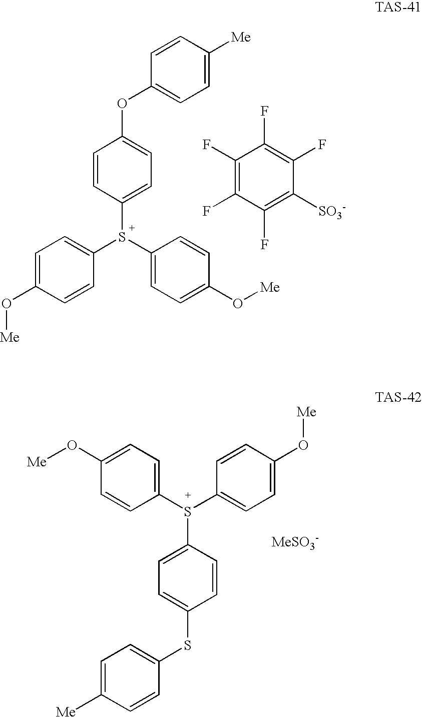

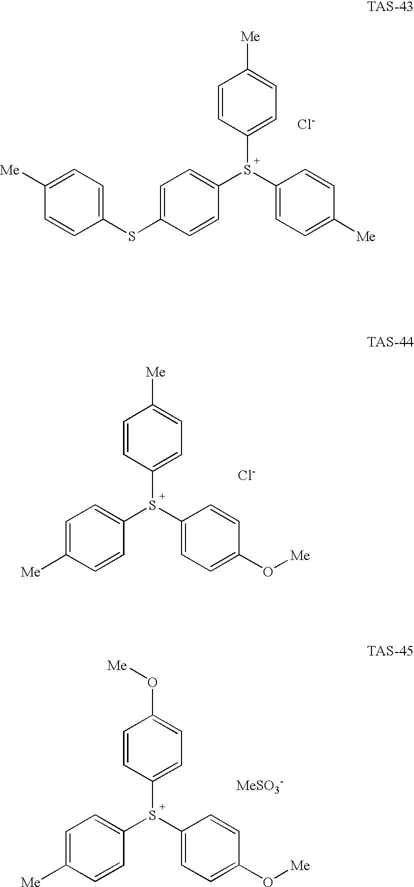

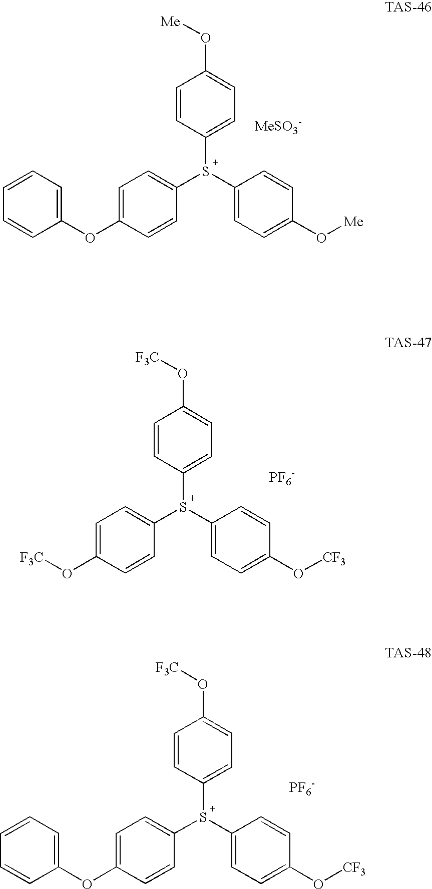

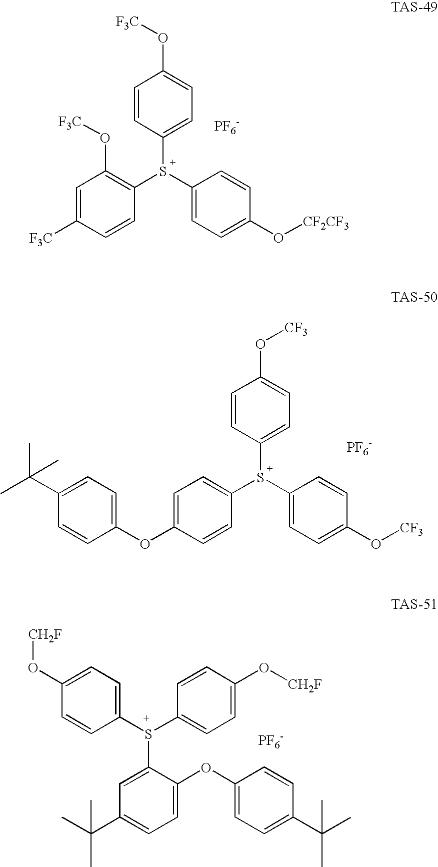

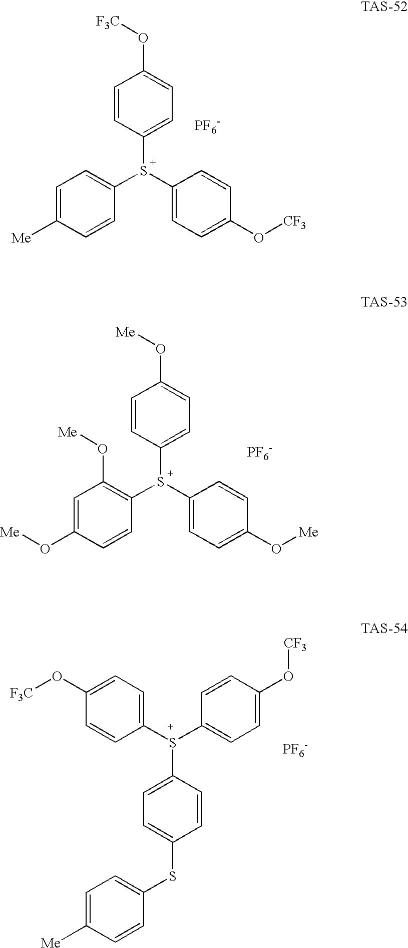

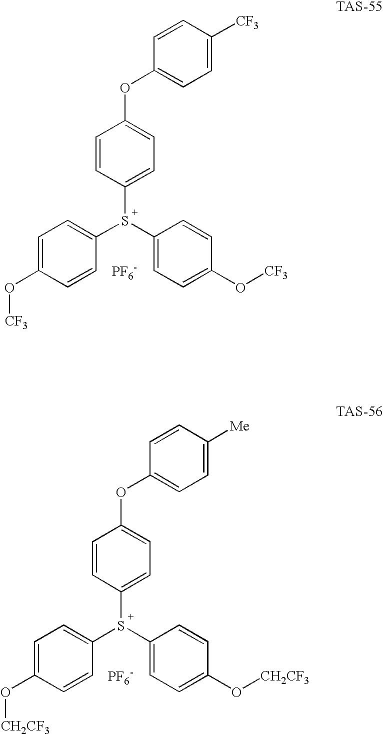

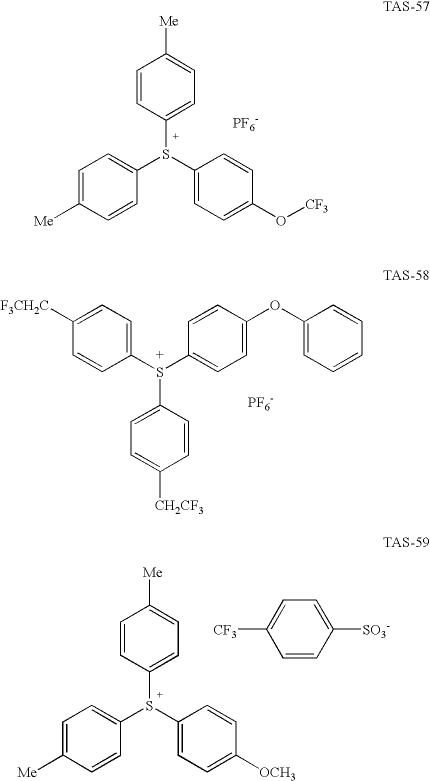

Photopolymerization accelerators include, for example, anthracene, anthracene derivatives (e.g., Adeka Optomer SP-100, produced by ADEKA DENKAKOGYO K.K.), phenothiazine (e.g., 10H-phenothiazine), and phenothiazine derivatives (e.g., 10-methylphenothiazine, 10-ethylphenothiazine, 10-decylphenothiazine, 10-acetylphenothiazine, 10-decylphenothiazine-5-oxide, 10-decylphenothiazine-5,5-dioxide, 10-acetylphenothiazine-5,5-dioxide). These photopolymerization accelerators are used singly or in their combination.

In addition to the foregoing constituent elements, the ink composition of this invention can employ various kinds of additives. Any coloring material which is soluble or dispersible in the main component of a polymeric compound is usable as coloring material for use in the ink composition of this invention and pigments are preferred in term of weather resistance. Preferred pigments usable in the invention are shown below:
C.I. Pigment Yellow—1, 3, 12, 13, 14, 17, 81, 83, 87, 95, 109, 42
C.I. Pigment Orange—16, 36, 38
C.I. Pigment Red—5, 22, 38, 48:1, 48:2, 48:4, 49:1, 53:1, 57:1, 63:1, 144, 146, 185, 101
C.I. Pigment Violet—19, 23
C.I. Pigment Blue—15:1, 15:3, 15:4, 18, 60, 27, 29
C.I. Pigment Green—7, 36
C.I. Pigment White—6, 18, 21
C.I. Pigment Black—7

Pigments described above can be dispersed using, for example, a ball mill, sand mill, atreiter, roll mill, agitator, Henschel mixer, colloid mill, ultrasonic homogenizer, pearl mill, wet jet mixer or paint shaker. There may be added dispersing agents when dispersing a pigment. Such a dispersing agent preferably is a polymeric dispersing agent and examples of a polymeric dispersing agent include Solsperse series, available from Avecia Co. A dispersing agent or a dispersing aid is incorporated preferably in an amount of from 1 to 50 parts by weight, based on 100 parts by weight of the pigment. There may be used a solvent or polymeric compound as a dispersing medium but the ink composition of this invention preferably contains no solvent to cause a reaction and curing immediately after deposition. A solvent remaining in a cured image produces problems such as deteriorated solvent resistance and VOC of the residual solvent. Polymeric compounds, rather than solvents are preferably used as a dispersing medium and in terms of dispersing suitability, it is preferred to choose monomers exhibiting viscosity as low as possible.

Pigment particles preferably have an average particle size of from 0.08 to 0.5 μm, and pigments, dispersing agents and dispersing medium are to be appropriately chosen and dispersing and filtering conditions are optimized so that the maximum particle size falls within the range from 0.3 to 10.0 μm and preferably from 0.3 to 3.0 μm. This particle size control can inhibit clogging in a head nozzle and maintains ink storage stability, ink transparency and curing sensitivity.

The ink composition of this invention preferably contains coloring material at a concentration of from 1% to 10% by weight of the total ink.

There may be used thermally base-generating agents to enhance ejection stability and storage stability. Preferred thermally base-generating agents usable in this invention include a salt of an organic acid and a base which is capable of decomposing upon heating through decarboxylation, a compound capable of decomposition via intramolecular nucleophilic substitution reaction, Lossen rearrangement or Beckmann rearrangement to generate an amine and a compound capable of causing reaction upon heating to generate a base. Specific examples of such compounds include trichloroacetic acid salt described in British Patent No. 998,949, α-sulfonylacetic acid salt described in U.S. Pat. No. 4,060,420, salts of propiolic acids described in JP-A 59-157637, salts of 2-carboxycarboxamide derivatives described in JP-A No. 0.59-168440, hydroxamcarbamates employing Lossen rearrangement described in JP-A No. 59-180537, and aldoxime carbamates capable of forming nitrile upon heating, described in JP-A No. 59-195237. There are also usable thermally base-generating agents described in British patent 998,945, U.S. Pat. No. 3,220,846, British Patent No. 279,480, JP-A Nos. 50-22625, 61-32844, 61-51139, 61-52638, 61-51140, 61-53634 through 61-53640, 61-55644, and 61-55645. Specific examples thereof include trichloroacetic acid guanidine, methyl trichloroacetate guanidine, potassium trichloroacetate, phenylsulfonylacetic acid guanidine, p-chlorophenylsulfonylacetic acid guanidine, p-methanesulfonylphenylsulfonylacetic acid guanidine, phenylpropiolic acid guanidine, cesium p-phenylenepropiolate, p-chlorophenylpropiolic acid guanidine, p-phenylene-bis-phenylpropiolic acid guanidine, phenylsulfonylacetic acid tetramethylammonium, and phenylpropiolic acid tetramethylammonium.

The ink composition of this invention may contain an acid breeder which is capable of newly generating an acid via an acid generated upon exposure to actinic rays, as described in JP-A Nos. 8-248561 and 9-34106.

The ink composition of this invention can be manufactured by dispersing a pigment together with an actinic energy ray-curable compound and a pigment-dispersing agent by using a dispersing machine such as a sand mill. The ink composition is prepared preferably by diluting a previously prepared, concentrated pigment solution, with an actinic energy ray-curable compound. Sufficient dispersion can be achieved by using a conventional dispersing machine, whereby excessive energy for dispersion is not consumed and a long dispersing time is not necessitated so that ink constituents are not easily deteriorated during dispersion, leading to preparation of an ink exhibiting superior stability. It is preferred to filter an ink with a filter having a pore size of not more than 3 μm (more preferably not more than 1 μm).

The ink composition of this invention preferably exhibits a relatively high viscosity of 5 to 50 mPa at 25° C. An ink with a viscosity of 5 to 50 mPa results in stable ejection characteristics not only in heads employing a frequency of 4 to 10 KHz but also in heads employing a high frequency of 10 to 50 KHz. A viscosity of less than 5 mPa results in deteriorated follow-up of ejection and a viscosity of more than 50 mPa results in deteriorated ejection characteristics even when a mechanism for lowering viscosity is built in, leading to failure in stability and ejection entirely becoming difficult.

The ink composition preferably exhibits an electric conductivity of not more than 10 μS/cm in piezo-heads, thereby preventing electrolytic erosion in the interior of such heads. A continuous type head necessitates to adjust a conductivity using an electrolyte, in which it is necessary to adjust conductivity to be 0.5 μS/cm or more.

The surface tension of an ink is preferably within the range of from 25 to 40 mN/m at 25° C. An ink surface tension of less than 25 mN/m makes it difficult to achieve stable ejection and a surface tension of more than 40 mN/m makes it difficult to obtain the intended dot diameter. When the surface tension is beyond the range of 25 to 40 mN/m, it becomes difficult to obtain a uniform dot diameter onto various supports even when ejected and light-exposed with controlling a viscosity and water content of an ink.

There may optionally be contained surfactants to control a surface tension. Preferred examples of surfactants usable in the ink composition of this invention include anionic surfactants such as dialkyl sulfonsuccinates, alkylnaphthalenesulfonates, and fatty acid salts; nonionic surfactants such as polyoxyethylene alkyl ethers, polyoxyethylene alkylallyl ethers, acetylene glycols and polyoxyethylene-polyoxypropylene block copolymer; cationic surfactants such as alkylamine salts and quaternary ammonium salts; and surface-active compounds containing a polymerizable group. Of these are preferred surface-active compounds containing a unsaturated bond or a polymerizable group such as oxirane or oxetane, such as a silicon-modified acrylate, fluorine-modified acrylatesilicon-modified epoxy, fluorine-modified epoxy, silicon-modified oxetane, and fluorine-modified oxetane.

In addition to the foregoing, the ink composition may further contain various additives. Examples thereof include leveling additives, matting agents, polyester type resins, polyurethane type resins, vinyl type resins, acryl type resins, rubber type resins and waxes to control physical properties of film. Addition of an extremely small amount of solvent is effective to improve contact fitness with a recording medium. In that case, addition within a range causing no problem such as solvent resistance or VOC is effective and the amount is from 0.1% to 5%, and preferably from 0.1% to 3%. A radical-cation hybrid type curing ink is feasible by the combination of a radical-polymerizable monomer and an initiator.

In the image forming method of this invention, an ink composition is ejected on the surface of a recording material to form an image through an ink jet printing system, followed by exposure to actinic rays such as ultraviolet rays to cure the formed image.

When ejected, ink is heated together with the ink jet nozzles to lower the viscosity of the ink liquid. The heating temperature is preferably from 30 to 80° C., and more preferably from 35 to 60° C.

After ink is deposited and exposed to actinic rays to perform curing, the overall ink layer thickness is preferably from 2 to 20 μm. In actinic ray-curing type ink jet recording in the field of screen printing, the overall ink layer thickness exceeds 20 μm under present conditions but in the field of soft package printing in which thin plastic material is used as a recording material, there are produced not only problems such as curling and wrinkling but also problems such that texture or feeling of printing material is wholly altered, making practical use difficult. The droplet volume ejected from the respective nozzles is preferably from 2 to 15 pl.

To form high definition images, the timing of exposure is preferably as soon as possible and it is preferred to start light-exposure at the timing when the viscosity or water content of ink reaches the preferable state. Preferred conditions for exposure to actinic rays, for example, are to start exposure to an actinic ray within 0.01 to 2.0 sec. (more preferably within 0.001 to 0.4 sec.) after deposition of ink, and it is also preferred to complete exposure after 0.1 to 3 sec. (more preferably within 0.2 to 1 sec.) after light exposure continues until ink fluidity vanishes. The foregoing conditions can prevent expansion of dot diameter and penetration between dots.

The basic method of exposure to actinic rays is disclosed in JP-A No. 60-132767. Thus, light sources are provided on both sides of a recording head unit and the recording head and the light sources are scanned by a shuttle system. Light exposure is started at an interval after ink deposition. Curing is completed by another undriven light source. U.S. Pat. No. 6,145,979 discloses an exposure method using fiberoptics and a method in which collimated light is irradiated onto a mirror provided on the side of a recording head unit to expose the recording portion to UV rays. Any of these exposure methods is applicable to the image forming method of this invention.

Exposure to actinic rays is divided into several steps. In one preferred embodiment, first, deposited ink is exposed to actinic rays within a period of 0.001 to 2.0 sec. after ink deposition, according to the methods described above and after completion of the whole printing, exposure to actinic rays is further carried out. Dividing exposure to actinic rays into two steps enables to minimize shrinkage of recording material, typically caused while ink is cured.

Light sources used for exposure to actinic rays include, for example, a mercury arc lamp, xenon arc lamp, fluorescent lamp, carbon arc lamp, tungsten-halogen copying lamp, high pressure mercury lamp, metal halide lamp, electrodeless UV lamp, low pressure mercury lamp, UV laser, xenon flash lamp, insect lamp, black light, bactericidal lamp, cold cathode tube and LED, but are not limited to these. Of these, the fluorescent lamp is preferable in terms of low energy consumption and low cost. Light sources having an emission peak at the wavelength of from 250 to 370 nm (preferably from 270 to 320 nm) are preferred in terms of sensitivity. The illuminance is preferably from 1 to 3000 mW/cm², and more preferably from 1 to 200 mW/cm². In the case of electron beam curing, curing is carried out usually by using an electron beam at an energy of 300 eV or less but instantaneous curing is feasible at an exposure amount of 1 to 5 Mrad.

Image printing onto a recording medium (or substrate) is conducted using the ink composition of this invention and any of the synthetic resins broadly employed for various uses can be utilized and examples thereof include polyester, polyvinyl chloride, polyethylene, polyurethane, polypropylene, acryl resin, polycarbonate, polystyrene, acrylonitrile-butadiene-styrene copolymer, polyethylene terephthalate, and polybutadiene terephthalate. The foregoing synthetic resin substrate is not limited with respect to thickness and form.

Substrates usable in this invention include a non-absorptive support as well as non-coated paper and coated paper and the use of a non-absorptive support as a substrate is preferred. Non-absorptive supports include various kinds of non-absorptive plastics and their films. Examples of plastic film include PET film, OPS film, OPP film, ONy film, PVC film, PE film, and TAC film. Other plastics include polycarbonate, acryl resin, ABS, polyacetal, PVA, and various rubbers. Further, metals and glass are also feasible. When images are formed on thermally shrinkable PET film, OPS film, OPP film, ONy film or PVC film, the constitution of this invention is effective. These substrates easily cause curling or deformation at the time of curing shrinkage or curing reaction of the ink and it is difficult for the ink layer to follow shrinkage of the substrate.

The various kinds of plastic films greatly differ in surface energy, resulting in problems arising from dot size change after deposition. This invention is applicable not only to plastic film exhibiting a relative low surface energy such as OPP film and OPS film but also to PET film exhibiting a relatively high surface energy, and a substrate exhibiting a wet index of 40 to 60 mN/m is preferred.

In this invention, a long-roll (web) recording material is advantageously used in terms of cost of the recording material such as packaging cost or production cost and print making efficiency.

### EXAMPLES

The present invention will be further described based on examples but embodiment of the invention is not limited to these.

### Example 1

### Preparation of Ink-Jet Ink

Preparation of Magenta Ink 101

There was prepared magenta ink 101 composed of the following composition. Thus, constituent compounds except for compounds of formula (a-1) or (a-2) were dispersed using a sand grinder for 4 hrs., then, a compound of formula (a-1) or (a-2) was added thereto, filtered through a 0.8 μm membrane filter and subjected to dehydration under reduced pressure with heating at 50° C. to prepare magenta ink 101.

| | | |
|---|---|---|
| C.I. Pigment Red 184 | 3 | wt. parts |
| SOLSPERSE 24000 (manufactured | 1 | wt. parts |
| by Avecia Corp.) | | |
| Exemplified Compound a-1 | 10 | wt. parts |
| (50% solid propylene carbonate solution) | | |
| Aronoxetane OXT-221 | 80 | wt. parts |
| Exemplified Compound EP-17 | 20 | wt. parts |

Preparation of Magenta Ink 102 Through 154

Similarly to the foregoing magenta ink 101, magenta inks 102 to 154 comprising ink composition according to this invention, provided that compounds of formula (a-1) or (a-2), epoxy compounds, oxetane compounds, pigments were used as shown in Table 1.

TABLE 1

| Ink | Compound-1*¹ | | Compound-2*² | Compound-3*³ | | Compound-4*⁴ | Compound-5*⁵ | Re- |
|---|---|---|---|---|---|---|---|---|
| No. | (*6) | | (*6) | (*6) | | (*6) | (*6) | mark |
| 101 | a-1 | (10) | — | EP-17 | (20) | OXT-221 (80) | P0 (3) | Inv. |
| 102 | a-2 | (10) | — | EP-17 | (20) | OXT-221 (80) | P0 (3) | Inv. |
| 103 | a-4 | (10) | — | EP-17 | (20) | OXT-221 (80) | P0 (3) | Inv. |
| 104 | a-5 | (10) | — | EP-17 | (20) | OXT-221 (80) | P0 (3) | Inv. |
| 105 | a-7 | (10) | — | EP-17 | (20) | OXT-221 (80) | P0 (3) | Inv. |
| 106 | a-16 | (10) | — | EP-17 | (20) | OXT-221 (80) | P0 (3) | Inv. |
| 107 | a-18 | (10) | — | EP-17 | (20) | OXT-221 (80) | P0 (3) | Inv. |
| 108 | a-25 | (10) | — | EP-17 | (20) | OXT-221 (80) | P0 (3) | Inv. |
| 109 | a-27 | (10) | — | EP-17 | (20) | OXT-221 (80) | P0 (3) | Inv. |
| 110 | a-28 | (10) | — | EP-17 | (20) | OXT-221 (80) | P0 (3) | Inv. |
| 111 | a-30 | (10) | — | EP-17 | (20) | OXT-221 (80) | P0 (3) | Inv. |
| 112 | a-31 | (10) | — | EP-17 | (20) | OXT-221 (80) | P0 (3) | Inv. |
| 113 | a-32 | (10) | — | EP-17 | (20) | OXT-221 (80) | P0 (3) | Inv. |
| 114 | a-1 | (10) | — | EP-61 | (20) | OXT-221 (80) | P0 (3) | Inv. |
| 115 | a-2 | (10) | — | EP-61 | (20) | OXT-221 (80) | P0 (3) | Inv. |
| 116 | a-4 | (10) | — | EP-61 | (20) | OXT-221 (80) | P0 (3) | Inv. |
| 117 | a-5 | (10) | — | EP-61 | (20) | OXT-221 (80) | P0 (3) | Inv. |
| 118 | a-7 | (10) | — | EP-61 | (20) | OXT-221 (80) | P0 (3) | Inv. |
| 119 | a-16 | (10) | — | EP-61 | (20) | OXT-221 (80) | P0 (3) | Inv. |
| 120 | a-18 | (10) | — | EP-61 | (20) | OXT-221 (80) | P0 (3) | Inv. |
| 121 | a-25 | (10) | — | EP-61 | (20) | OXT-221 (80) | P0 (3) | Inv. |
| 122 | a-27 | (10) | — | EP-61 | (20) | OXT-221 (80) | P0 (3) | Inv. |
| 123 | a-1 | (10) | — | EP-66 | (20) | OXT-221 (80) | P0 (3) | Inv. |
| 124 | a-2 | (10) | — | EP-66 | (20) | OXT-221 (80) | P0 (3) | Inv. |
| 125 | a-4 | (10) | — | EP-66 | (20) | OXT-221 (80) | P0 (3) | Inv. |
| 126 | a-5 | (10) | — | EP-66 | (20) | OXT-221 (80) | P0 (3) | Inv. |
| 127 | a-7 | (10) | — | EP-66 | (20) | OXT-221 (80) | P0 (3) | Inv. |
| 128 | a-16 | (10) | — | EP-66 | (20) | OXT-221 (80) | P0 (3) | Inv. |
| 129 | a-18 | (10) | — | EP-66 | (20) | OXT-221 (80) | P0 (3) | Inv. |
| 130 | a-25 | (10) | — | EP-66 | (20) | OXT-221 (80) | P0 (3) | Inv. |
| 131 | a-27 | (10) | — | EP-66 | (20) | OXT-221 (80) | P0 (3) | Inv. |
| 132 | a-1 | (10) | — | EP-67 | (20) | OXT-221 (80) | P0 (3) | Inv. |
| 133 | a-2 | (10) | — | EP-67 | (20) | OXT-221 (80) | P0 (3) | Inv. |
| 134 | a-4 | (10) | — | EP-67 | (20) | OXT-221 (80) | P0 (3) | Inv. |
| 135 | a-5 | (10) | — | EP-67 | (20) | OXT-221 (80) | P0 (3) | Inv. |
| 136 | a-7 | (10) | — | EP-67 | (20) | OXT-221 (80) | P0 (3) | Inv. |
| 137 | a-16 | (10) | — | EP-67 | (20) | OXT-221 (80) | P0 (3) | Inv. |
| 138 | a-18 | (10) | — | EP-67 | (20) | OXT-221 (80) | P0 (3) | Inv. |
| 139 | a-25 | (10) | — | EP-67 | (20) | OXT-221 (80) | P0 (3) | Inv. |
| 140 | a-27 | (10) | — | EP-67 | (20) | OXT-221 (80) | P0 (3) | Inv. |
| 141 | a-4 | (10) | — | EP-17 | (20) | OXT-221 (80) | P1 (3) | Inv. |
| 142 | a-4 | (10) | — | EP-17 | (20) | OXT-221 (80) | P2 (3) | Inv. |
| 143 | a-4 | (15) | — | EP-17 | (20) | OXT-221 (80) | P1 (3) | Inv. |
| 144 | a-4 | (15) | — | EP-17 | (20) | OXT-221 (80) | P2 (3) | Inv. |
| 145 | a-4 | (5) | TAS-13 (5) | EP-17 | (20) | OXT-221 (80) | P1 (3) | Inv. |
| 146 | a-4 | (5) | TAS-13 (5) | EP-17 | (20) | OXT-221 (80) | P2 (3) | Inv. |
| 147 | a-4 | (10) | TAS-13 (5) | EP-17 | (20) | OXT-221 (80) | P1 (3) | Inv. |
| 148 | a-4 | (10) | TAS-13 (5) | EP-17 | (20) | OXT-221 (80) | P2 (3) | Inv. |
| 149 | a-4 | (10) | — | 3000*⁷ | (20) | OXT-221 (80) | P0 (3) | Comp. |
| 150 | a-4 | (10) | — | 2021*⁷ | (20) | OXT-221 (80) | P0 (3) | Comp. |

| | | | | | | | |
|---|---|---|---|---|---|---|---|
| 151 | — | UVI-6990 (10) | EP-17 | (20) | OXT-221 (80) | P0 (3) | Comp. |
| 152 | — | UVI-6990 (10) | EP-17 | (20) | OXT-221 (80) | P0 (3) | Comp. |
| 153 | — | UVI-6990 (10) | *2 3000 | (20) | OXT-221 (80) | P0 (3) | Comp. |
| 154 | — | UVI-6990 (10) | *2 2021P | (20) | OXT-221 (80) | P0 (3) | Comp. |

*1: compound of formula (a-1) or (a-2), 50% propylene carbonate solution
*2: phtolytically acid-generating agent
*3: epoxy compound
*4: oxetane compound
*5: pigment
*6: wt. part(s)
*7: coeroxide

Details of compounds shown in Table 1 are as follows.

P0: C.I. Pigment Red 184

P1: 250 parts of crude copper phthalocyanine (“Copper Phthalocyanine” manufactured by Toyo Ink Seizo Co., Ltd., 2500 parts of sodium chloride and 160 parts of polyethylene glycol (Polyethylene Glycol 300, manufactured by Tokyo Kasei Co.) were fed into 4.55 L (1 gal.) kneader made of styrene (manufactured by Inoue Seisakusho Co.) and kneaded for 3 hr. Then, the mixture was fed into 2.5 l of hot water and stirred with a high-speed mixer fir 1 hr. to form slurry, while heating at 80° C., filtered and washed with water 5 times to remove sodium chloride and solvent, and subsequently spray-dried to obtain pigment P1.

P2: Similarly to P1, 250 parts of quinacridone type red pigment (CINQUASIA MAGENTA. RT-355-D, manufactured by Ciba Geigy), 2500 parts of sodium chloride and 60 parts of Polyethylene Glycol 300 were fed into 4.55 L (1 gal.) kneader made of styrene to obtain pigment P2.

Epoxy Compound:

Coeroxide 3000: aliphatic epoxy (manufactured by Daicel UCB)
Coeroxide 2021P: aliphatic epoxy (manufactured by Daicel UCB)
   Photolytically Acid-Generating Agent:
UV16990: triphenylsulfonium salt (Silacure UVI6990, Union Carbide)
   Oxetane Compound:
OXT-221: di[1-ethyl(3-oxetanyl)]methyl ether (manufactured by Toagosei Kagaku Kogyo)
   Ink Jet Image Recording and Evaluation

Using each of the thus prepared magenta inks, image recording and evaluation thereof were conducted according to the following procedure.

Image Evaluation A

Using each of the magenta inks, an piezo-type ink-jet nozzle (nozzle pitch of 360 dpi) with heat-controlling the nozzle portion at 50° C. to realize a droplet volume of 7 pl, each of the magenta inks was deposited onto a polyethylene terephthalate film substrate which was previously subjected to corona discharge to print a magenta solid image (ink coverage of 10 g/m²) and 6 point MS Ming-style type letters. Using a fluorescent lamp light source of having a main peak at 308 nm, exposure right below the light source was started 0.3 sec after deposition under the condition of an illuminance of 10 mW/cm on the surface of the substrate and exposure was completed 0.8 sec. later. The exposure energy was 5 mJ/cm². This image printing was conducted under an environment of 30° C. and 50% RH.

The thus obtained images were evaluated as follows.

Ink Curability

Printed images were evaluated with respect to ink curability, based on the following criteria:
A: no tackiness in images was noted even when touched immediately after completion of exposure,
B: slight tackiness was noted when touched immediately after completion of exposure but no tackiness after 1 min.,
C: tackiness remained even 1 min. after completion of exposure.
   Adhesion to Substrate

Onto a solid image, a 25 mm wide strip of cellophane tape (R) was adhered, strongly pressed and peeled at a peeling angle of 90°. After peeling, the image was visually observed and evaluated with respect to substrate adhesion, based on the following criteria:
A: no portions of image were peeled even by tape peeling,
B: the image was partially peeled by tape peeling,
C: the image was overall peeled by tape peeling.
   Resistance to Image Bleeding

MS Ming-style letters of 6 point were observed using a magnifier and evaluated with respect to image bleeding, based on the following criteria:
A: bleeding between two dots was rarely noted,
B: bleeding between two dots was slightly noted,
C: markedly bleeding among dots was noted.
   Resistance to Bending

Using each of the inks, two samples of a solid magenta image at a coverage of 10 g/m² and 14 g/m² were prepared and wound half way around onto a 6 mm stainless steel rod with the ink-adhered face outward. When slowly bent so that the substrate became substantially parallel, the image was observed with a magnifier and evaluated with respect to bending resistance, based on the following criteria:
A: marked cracking was not noted in the bent image area,
B: a few cracks were observed in the image area,
C: a large number of cracks were observed in the image area.

Evaluation results are shown in Table 2.

TABLE 2

| Ink | Ink | Adhesion to | Bleeding | Bending | |
|---|---|---|---|---|---|
| No. | Curability | Substrate | Resistance | Resistance | Remark |
| 101 | A | A | A | A | Inv. |
| 102 | A | A | A | A | Inv. |
| 103 | A | A | A | A | Inv. |
| 104 | A | A | A | A | Inv. |
| 105 | A | A | A | A | Inv. |
| 106 | A | A | A | A | Inv. |
| 107 | A | A | A | A | Inv. |
| 108 | A | A | A | A | Inv. |
| 109 | A | A | A | A | Inv. |
| 110 | A | A | A | A | Inv. |
| 111 | A | A | A | A | Inv. |
| 112 | A | A | A | A | Inv. |
| 113 | A | A | A | A | Inv. |
| 114 | A | A | A | A | Inv. |
| 115 | A | A | A | A | Inv. |
| 116 | A | A | A | A | Inv. |
| 117 | A | A | A | A | Inv. |
| 118 | A | A | A | A | Inv. |
| 119 | A | A | A | A | Inv. |
| 120 | A | A | A | A | Inv. |
| 121 | A | A | A | A | Inv. |
| 122 | A | A | A | A | Inv. |
| 123 | A | A | A | A | Inv. |
| 124 | A | A | A | A | Inv. |
| 125 | A | A | A | A | Inv. |
| 126 | A | A | A | A | Inv. |
| 127 | A | A | A | A | Inv. |
| 128 | A | A | A | A | Inv. |
| 129 | A | A | A | A | Inv. |
| 130 | A | A | A | A | Inv. |
| 131 | A | A | A | A | Inv. |
| 132 | A | A | A | A | Inv. |
| 133 | A | A | A | A | Inv. |
| 134 | A | A | A | A | Inv. |
| 135 | A | A | A | A | Inv. |
| 136 | A | A | A | A | Inv. |
| 137 | A | A | A | A | Inv. |
| 138 | A | A | A | A | Inv. |
| 139 | A | A | A | A | Inv. |
| 140 | A | A | A | A | Inv. |
| 141 | A | A | A | A | Inv. |
| 142 | A | A | A | A | Inv. |
| 143 | A | A | A | A | Inv. |
| 144 | A | A | A | A | Inv. |
| 145 | A | A | A | A | Inv. |
| 146 | A | A | A | A | Inv. |
| 147 | A | A | A | A | Inv. |
| 148 | A | A | A | A | Inv. |
| 149 | A | A | A | B | Comp. |
| 150 | A | A | A | B | Comp. |
| 151 | A | A | A | C | Comp. |
| 152 | A | A | A | C | Comp. |
| 153 | A | A | A | C | Comp. |
| 154 | A | A | A | C | Comp. |

As is apparent from Table 2, it was proved that ink-jet ink compositions of this invention exhibited superior ink curability and close adhesion onto the substrate, resulting in a high quality image without causing bleeding of the image. Even when the solid image portion was bent, no marked cracking was observed in the image portion, as compared to comparative examples. Thus, there were obtained a UV-curable inks for use in ink-jet recording, providing images exhibiting superior bending resistance.

1. An ink composition for ink jet printing comprising a compound represented by the following formula (a-1) or (a-2) and an alicyclic epoxy compound represented by the following formula (b) 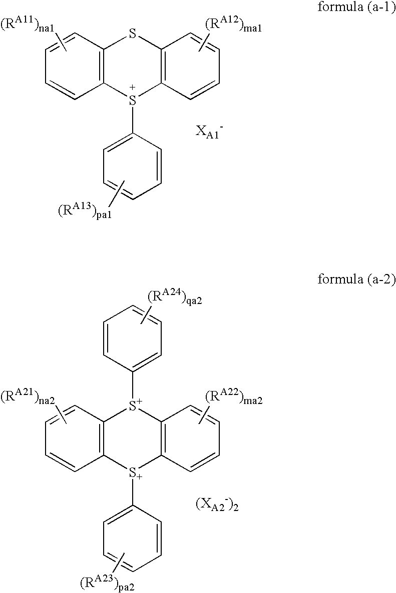
wherein R^{A11}, R^{A12}, R^{A13}, R^{A21}, R^{A22}, R^{A23} and R^{A24} are each a substituent; na1, na2, ma1 and ma2 are each an integer of from 0 to 4; pa1, pa2, qa1 and qa2 are each an integer of from 0 to 5; X_{A1}⁻ and X_{A2}⁻ are each a counter anion; 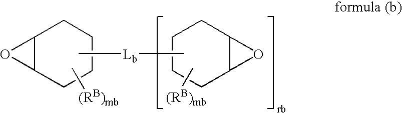
wherein R^{B} is a substituent; mb is an integer of from 1 to 3 and rb is an integer of from 1 to 3; L_{b} is a (rb+1)-valent linkage group having 1 to 15 carbon atoms or a single bond.

2. The ink composition of claim 1, wherein the alicyclic epoxy compound of formula (b) is represented by the following formula (A): 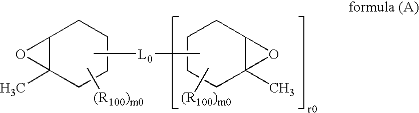
wherein R₁₀₀ is a substituent; m0 is an integer of from 0 to 2 and r0 is an integer of from 1 to 3; L₀ is a (r0+1)-valent linkage group having 1 to 15 carbon atoms or a single bond.

3. The ink composition of claim 2, wherein the alicyclic epoxy compound of formula (A) is represented by the following formula (I) or (II): 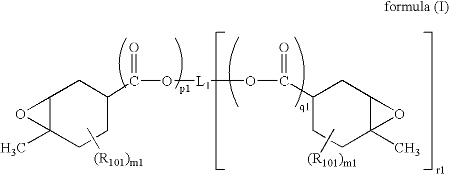
wherein R₁₀₁ is a substituent; m1 is an integer of from 0 to 2, p1 and q1 are each 0 or 1, and r1 is an integer of from 1 to 3; L₁ is a (r1+1)-valent linkage group having 1 to 15 carbon atoms or a single bond; 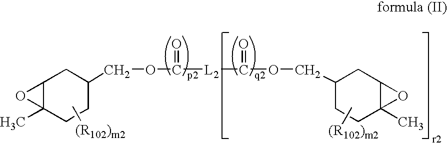
wherein R₁₀₂ is a substituent; m2 is an integer of from 0 to 2, p2 and q2 are each 0 or 1, and r2 is an integer of from 1 to 3; L₂ is a (r2+1)-valent linkage group having 1 to 15 carbon atoms or a single bond.

4. The ink composition of claim 1, wherein the ink composition further comprises an oxetane compound.

5. The ink composition of claim 1, wherein the ink composition further comprises a photolytically acid-generating agent.

6. The ink composition of claim 5, wherein the photolytically acid-generating agent is a compound represented by the following formula (I-1), (I-2) or (I-3): 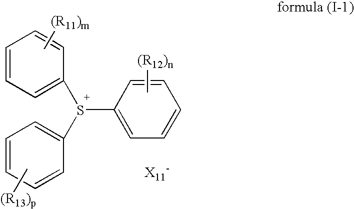
wherein R₁₁, R₁₂ and R₁₃ are each a substituent; m, n and p are each an integer of from 0 to 5; X₁₁⁻ is a counter anion; 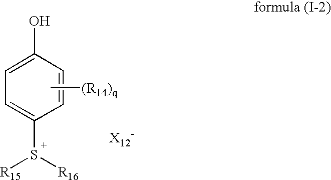
wherein R₁₄ is a substituent; q is an integer of from 0 to 2; R₁₅ and R₁₆ are each an alkyl group, an alkenyl group, an alkynyl group or an aryl group; X₁₂⁻ is a counter anion; 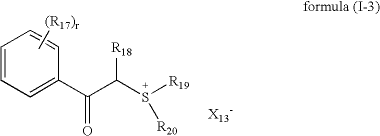
wherein R₁₇ is a substituent; r is an integer of from 0 to 3; R₁₈ is a hydrogen atom or an alkyl group; R₁₉ and R₂₀ are each an alkyl group, an alkenyl group, an alkynyl group or an aryl group; X₁₃⁻ is a counter anion.

7. The ink composition of formula 6, wherein the compound represented by formula (I-1) is represented by the following formula (T-1): 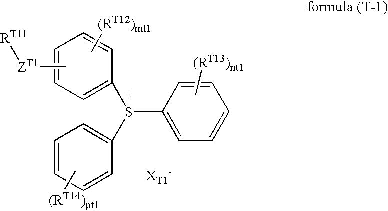
wherein R^{T11} and R^{T12} are each an alkyl group or an aromatic group; Z^{T1} is an oxygen atom or sulfur atom; R^{T13} and R^{T14} are each an alkyl group, an aromatic group, an alkoxy group, an aryloxy group, an alkylthio group or an arylthio group; mt1 is an integer of from 0 to 4, nt1 and pt1 are each an integer of from 1 to 5; X_{T1} is a counter anion.

8. An image forming method comprising the steps of:
(a) ejecting a droplet of an ink composition through recording head with at least one nozzle and onto a surface of a recording material and
(b) exposing the recording material with the ink composition on the surface thereof to an actinic ray to cure the ink composition,
wherein the ink composition comprises a compound represented by the following formula (a-1) or (a-2) and an alicyclic epoxy compound represented by the following formula (b): 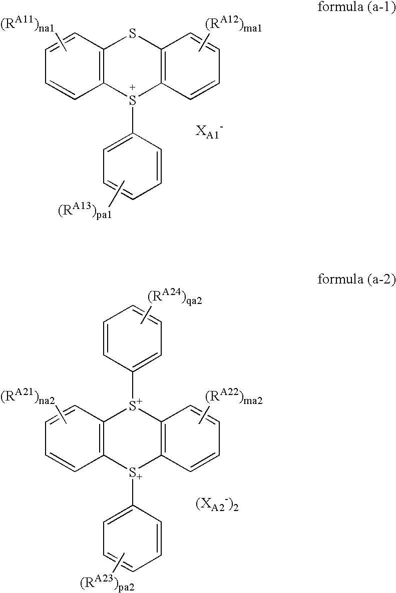
wherein R^{A11}, R^{A12}, R^{A13}, R^{A21}, R^{A22}, R^{A23} and R^{A24} are each a substituent; na1, na2, ma1 and ma2 are each an integer of from 0 to 4; pa1, pa2, qa1 and qa2 are each an integer of from 0 to 5; X_{A1}⁻ and X_{A2}⁻ are each a counter anion; 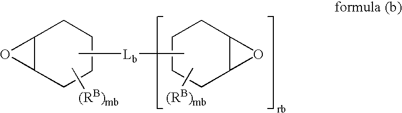
wherein R^{B} is a substituent; mb is an integer of from 1 to 3 and rb is an integer of from 1 to 3; L_{b} is a (rb+1)-valent linkage group having 1 to 15 carbon atoms or a single bond.

9. The image forming method of claim 8, wherein in step (a), the ink composition is heated at a temperature of from 30 to 80° C. before ejected.

10. The image forming method of claim 8, wherein in step (b), the recording material is exposed within 0.001 to 2.0 sec. after the ink composition is ejected on the surface of the recording material and exposure is performed for from 0.1 to 3.0 sec.

11. The image forming method of claim 8, wherein the alicyclic epoxy compound of formula (b) is represented by the following formula (A): 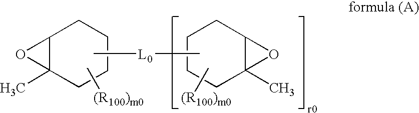
wherein R₁₀₀ is a substituent; m0 is an integer of from 0 to 2 and r0 is an integer of from 1 to 3; L₀ is a (r0+1)-valent linkage group having 1 to 15 carbon atoms or a single bond.

12. The image forming method of claim 11, wherein the alicyclic epoxy compound of formula (A) is represented by the following formula (I) or (II): 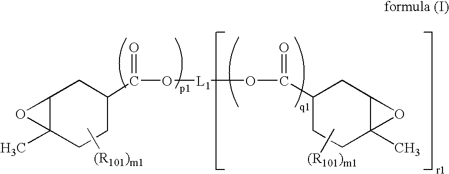
wherein R₁₀₁ is a substituent; m1 is an integer of from 0 to 2, p1 and q1 are each 0 or 1, and r1 is an integer of from 1 to 3; L₁ is a (r1+1)-valent linkage group having 1 to 15 carbon atoms or a single bond; 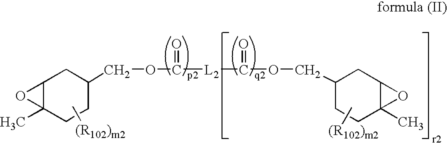
wherein R₁₀₂ is a substituent; m2 is an integer of from 0 to 2, p2 and q2 are each 0 or 1, and r2 is an integer of from 1 to 3; L₂ is a (r2+1)-valent linkage group having 1 to 15 carbon atoms or a single bond.

13. The image forming method of claim 8, wherein the ink composition further comprises an oxetane compound.

14. The image forming method of claim 8, wherein the ink composition further comprises a photolytically acid-generating agent.

15. The image forming method of claim 14, wherein the photolytically acid-generating agent is a compound represented by the following formula (I-1), (I-2) or (I-3): 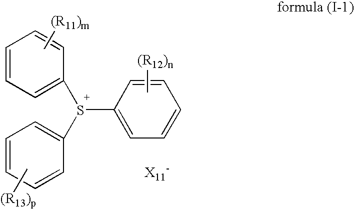
wherein R₁₁, R₁₂ and R₁₃ are each a substituent; m, n and p are each an integer of from 0 to 5; X₁₁⁻ is a counter anion; 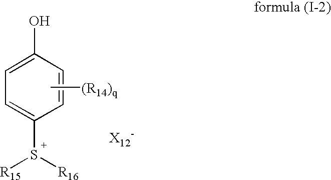
wherein R₁₄ is a substituent; q is an integer of from 0 to 2; R₁₅ and R₁₆ are each an alkyl group, an alkenyl group, an alkynyl group or an aryl group; X₁₂⁻ is a counter anion; 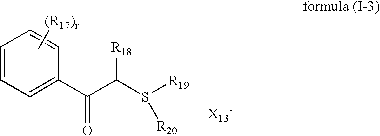
wherein R₁₇ is a substituent r is an integer of from 0 to 3; R₁₈ is a hydrogen atom or an alkyl group; R₁₉ and R₂₀ are each an alkyl group, an alkenyl group, an alkynyl group or an aryl group; X₁₃⁻ is a counter anion.

16. The image forming method of formula 15, wherein the compound represented by formula (I-1) is represented by the following formula (T-1): 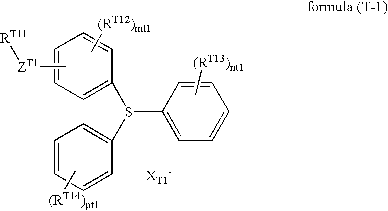
wherein R^{T11} and R^{T12} are each an alkyl group or an aromatic group; Z^{T1} is an oxygen atom or sulfur atom; R^{T13} and R^{T14} are each an alkyl group, an aromatic group, an alkoxy group, an aryloxy group, an alkylthio group or an arylthio group; mt1 is an integer of from 0 to 4, nt1 and pt1 are each an integer of from 1 to 5; X_{T1} is a counter anion.
